(19) United States
(12) Patent Application Publication
(10) Pub. No.: US 2024/0267188 A1
(43) Pub. Date: Aug. 8, 2024

(54) COMPONENT CHIP FOR WIRELESS COMMUNICATION

(71) Applicant: QUALCOMM Incorporated, San Diego, CA (US)

(72) Inventors: Ahmed Ragab ELSHERIF, San Jose, CA (US); Youhan KIM, Saratoga, CA (US); Guido Robert FREDERIKS, Watsonville, CA (US); Didier Johannes Richard VAN NEE, Tull en 't Waal (NL); Kapil RAI, Sunnyvale, CA (US); Nicholas KUCHAREWSKI, San Jose, CA (US)

(21) Appl. No.: 18/166,350

(22) Filed: Feb. 8, 2023

(51) Int. Cl. H04L 5/00

(52) U.S. Cl. CPC H04L 5/0053; H04B 7/0452; H04W 84/12

(57) ABSTRACT

Various aspects of the present disclosure generally relate to wireless communication. For example, a wireless communication device (WCD), may include multiple component chips configurable to work together as a partitioned chip having a capability to communicate using a quantity of spatial streams that exceeds a capacity of any one of the multiple component chips when operated independently. Some aspects more specifically relate to component chips having frequency domain components that support a first quantity of spatial streams in a frequency domain and having time domain components that support a second quantity of spatial streams in a time domain. In some examples, the first quantity of spatial streams may correspond to a quantity of spatial streams that are transmitted or received by multiple component chips, and the second quantity of spatial streams may correspond to a quantity of spatial streams that are transmitted or received by a single component chip.

### FIELD OF THE DISCLOSURE

Aspects of the present disclosure generally relate to wireless communication and specifically, to techniques and apparatuses for communicating using multiple component chips as a combined effective chip capable of communicating using a quantity of spatial streams that exceeds a capacity of any one of the multiple component chips when operated independently.

### BACKGROUND

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a wireless communication device (WCD), such as an access point, may be configured with a communication chip (for example, including a modem, a set of antennas, or a set of processing components) to communicate over the air with another WCD. The communication chip may be configured with a quantity of antennas based on a planned usage of the WCD, cost constraints, or throughput gains desired for the WCD. For example, an 8×8 configuration (for example, where the communication chip is configured to communicate using up to 8 antennas, with the other WCD having up to 8 antennas) improves diversity gain and range compared to a 4×4 configuration. Additionally or alternatively, an 8×8 configuration may improve multiple user (MU)-multiple-input multiple-output (MIMO) throughput (for downlink (DL) or uplink (UL)) compared to a 4×4 configuration. However, a cost of the 8×8 configuration may be significantly higher than a cost of a 4×4 configuration.

For these reasons, some enterprise users, with a priority of performance, may prefer an 8×8 configuration. However, some retail users or carrier users, with a priority of cost reduction, may prefer a 4×4 configuration. Manufacturers of communication chips may choose to manufacture an 8×8 configuration only (an unnecessarily expensive option for retail users and carrier users), to manufacture a 4×4 configuration only (failing to satisfy performance preferences of enterprise customers), or to manufacture both 4×4 and 8×8 configurations (with increased engineering and manufacturing costs, multiple tape-outs and multiple bring-up procedures for manufacturing).

### SUMMARY

The systems, methods, and devices of this disclosure each have several innovative aspects, no single one of which is solely responsible for the desirable attributes disclosed herein.

Some aspects described herein relate to a component chip for wireless communication. The component chip may include a set of one or more frequency domain components configurable to process a set of spatial streams in a frequency domain and select a proper subset of spatial streams from the set of spatial streams. The component chip may also include a frequency-to-time domain mapping component configured to map the proper subset of spatial streams from the frequency domain to a time domain. The component chip may further include a set of one or more time domain components configured to receive, from the frequency-to-time domain mapping component, the proper subset of spatial streams in the time domain and to transmit the proper subset of spatial streams.

Some aspects described herein relate to a system that includes the component chip and one or more additional component chips configured to transmit respective subsets of spatial streams. The system may further include a chip-to-chip bus configured to couple the set of one or more frequency domain components to an additional set of frequency domain components of the one or more additional component chips. The system may include, or may be included in, a wireless communication device (WCD), such as an access point (AP) or a wireless station (STA).

Some aspects described herein relate to a component chip for wireless communication. The component chip may include a set of one or more time domain components configured to receive a first proper subset of a set of spatial streams in a time domain. The component chip may also include a time-to-frequency domain mapping component, the time-to-frequency domain mapping component configured to receive the first proper subset of the set of spatial streams in the time domain from the set of one or more time domain components and to provide the first proper subset of the set of spatial streams in a frequency domain to a component of a set of one or more frequency domain components. The component chip may further include the component of the set of one or more frequency domain components, which is configured to receive the first proper subset of the set of spatial streams in the frequency domain from the time-to-frequency domain mapping component of the component chip and to receive a second proper subset of the set of spatial streams in the frequency domain from one or more additional component chips.

Some aspects described herein relate to a system that includes the component chip and one or more additional component chips. The system may further include a chip-to-chip bus configured to couple the set of one or more frequency domain components to an additional set of frequency domain components of the one or more additional component chips. The system may include, or may be included in, a WCD, such as an AP or a STA.

Some aspects described herein relate to a method for wireless communication performable at a WCD. The method may include transmitting an indication of a total quantity of spatial streams supported by the WCD, the total quantity of spatial streams being a sum of a first quantity of spatial streams supported by a first component chip of the WCD and a second quantity of spatial streams supported by a second component chip of the WCD. The method may include communicating using one or more of the first component chip or the second component chip.

Some aspects described herein relate to a WCD for wireless communication. The WCD may include at least one memory and at least one processor communicatively coupled with the at least one memory. The at least one processor may be operable to cause the WCD to transmit an indication of a total quantity of spatial streams supported by the WCD, the total quantity of spatial streams being a sum of a first quantity of spatial streams supported by a first component chip of the WCD and a second quantity of spatial streams supported by a second component chip of the WCD. The at least one processor may be operable to cause the WCD to communicate using one or more of the first component chip or the second component chip.

Some aspects described herein relate to a non-transitory computer-readable medium that stores a set of instructions for wireless communication by a WCD. The set of instructions, when executed by one or more processors of the WCD, may cause the WCD to transmit an indication of a total quantity of spatial streams supported by the WCD, the total quantity of spatial streams being a sum of a first quantity of spatial streams supported by a first component chip of the WCD and a second quantity of spatial streams supported by a second component chip of the WCD. The set of instructions, when executed by one or more processors of the WCD, may cause the WCD to communicate using one or more of the first component chip or the second component chip.

Some aspects described herein relate to an apparatus for wireless communication. The apparatus may include means for transmitting an indication of a total quantity of spatial streams supported by the WCD, the total quantity of spatial streams being a sum of a first quantity of spatial streams supported by a first component chip of the WCD and a second quantity of spatial streams supported by a second component chip of the WCD. The apparatus may include means for communicating using one or more of the first component chip or the second component chip.

Aspects generally include a method, apparatus, system, computer program product, non-transitory computer-readable medium, user equipment (UE), STA, AP, network node, network entity, wireless communication device, or processing system as substantially described with reference to and as illustrated by the drawings and specification.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 shows a block diagram of an example wireless communication network.

FIG. 2 illustrates an example of transmission component chips and an example of reception component chips.

FIG. 3 illustrates an example of a wireless communication device (WCD) having a first component chip and a second component chip coupled to form a partitioned component chip.

FIG. 4 illustrates an example of component chips that are coupled to be used as a partitioned component chip that supports a quantity of spatial streams that is greater than a quantity supported by any one of the component chips individually.

FIG. 5 illustrates an example of component chips that are coupled to be used as a partitioned component chip that supports a transmission of a quantity of spatial streams that is greater than a quantity supported by one of the component chips individually.

FIG. 6 illustrates an example of component chips that are coupled to be used as a partitioned component chip that supports a transmission of a quantity of spatial streams that is greater than a quantity supported by one of the component chips individually.

FIG. 7 illustrates an example of component chips that are coupled to be used as a partitioned component chip that supports a transmission of a quantity of spatial streams that is greater than a quantity supported by one of the component chips individually.

FIG. 8 illustrates an example of component chips that are coupled to be used as a partitioned component chip that supports a reception of a quantity of spatial streams that is greater than a quantity supported by one of the component chips individually.

FIG. 9 illustrates an example of component chips that are coupled to be used as a partitioned component chip that supports a reception of a quantity of spatial streams that is greater than a quantity supported by one of the component chips individually.

FIG. 10 illustrates an example of component chips that are coupled to be used as a partitioned component chip that supports a reception of a quantity of spatial streams that is greater than a quantity supported by one of the component chips individually.

FIG. 11 shows a protocol for providing data between component chips, as described in the context of the aspects described herein.

FIG. 12 illustrates an example of component chips that are coupled to be used as a partitioned component chip that supports a reception of a quantity of spatial streams that is greater than a quantity supported by one of the component chips individually.

FIG. 13 illustrates an example of component chips that are coupled to be used as a partitioned component chip that supports a reception of a quantity of spatial streams that is greater than a quantity supported by one of the component chips individually.

FIG. 14 illustrates an example of component chips that are coupled to be used as a partitioned component chip that supports communication of a quantity of spatial streams that is greater than a quantity supported by one of the component chips individually.

FIG. 15 is a diagram of an example associated with communicating using multiple component chips as a combined effective chip capable of communicating using a quantity of spatial streams that exceeds a capacity of any one of the multiple component chips when operated independently, in accordance with the present disclosure.

FIG. 16 is a flowchart illustrating an example process performed, for example, by a WCD that supports communicating using multiple component chips as a combined effective chip capable of communicating using a quantity of spatial streams that exceeds a capacity of any one of the multiple component chips when operated independently, in accordance with the present disclosure.

FIG. 17 is a diagram of an example apparatus for wireless communication that supports communicating using multiple component chips as a combined effective chip capable of communicating using a quantity of spatial streams that exceeds a capacity of any one of the multiple component chips when operated independently, in accordance with the present disclosure.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to a wireless communication device (WCD) such as a wireless access point (AP) or a wireless station (STA), that includes multiple component chips that may be configured to work together as a partitioned chip having a capability to communicate using a quantity of spatial streams that exceeds a capacity of any one of the multiple component chips when operated independently. Some aspects more specifically relate to component chips having frequency domain components that support a first quantity of spatial streams in a frequency domain and having time domain components that support a second quantity of spatial streams in a time domain. The first quantity may be greater than the second quantity. In some examples, the first quantity of spatial streams may correspond to a quantity of spatial streams that are transmitted or received collectively by multiple component chips, and the second quantity of spatial streams may correspond to a quantity of spatial streams that are transmitted or received by each component chip individually. In this way, the frequency domain components of a component chip (for example, a master chip, a primary chip, a secondary chip, a slave chip) may support processing of all spatial streams that the WCD communicates, and the time domain component may process only a subset of spatial streams.

Based on the time domain components, including radio frequency (RF) antennas (RFAs), processing only a subset of spatial streams, the component chip may have a reduced complexity, reduced manufacturing cost, and may be used in additional implementations when compared to a component chip that supports processing of all spatial streams in the time domain and in the frequency domain. For example, the component chip may be a 4×4 component chip that can be used in devices that are intended to support only 4 spatial streams, or the component chip may be used along with one or more additional 4×4 component chips to support additional spatial streams. The component chip and the one or more additional component chips may be configured to communicate on a same frequency channel, such that an additional WCD may perceive the WCD as a single 8×8 WCD, a single 12×12 WCD, a single 16×16 WCD, etc.

Particular aspects of the subject matter described in this disclosure can be implemented to realize one or more of the following potential advantages. In some examples, by supporting coupling of multiple component chips together, the described techniques and component chips can be used to reduce manufacturing costs associated with manufacturing multiple types of component chips with different numbers of antennas. Additionally or alternatively, by supporting coupling of multiple component chips together, the described techniques can allow a single configuration of component chips having N antennas to be used in applications with N, 2N, 3N, etc. combined antennas. In this way, the single configuration may be used to satisfy demands of different types of consumers and use cases, such as for retail customers, carrier customers, and enterprise customers with different priorities of cost and performance.

In this way, a WCD that has more than one component chip (for example, a 4×4 chip) may combine two component chips (for example, APs or STAs) to achieve performance of a 2N×2N component chip (also referred to as a partitioned component chip). The 2N×2N component chip may provide, as compared to a standard N×N architecture, increased transmission beamforming and MU-MIMO gain, increased range, reduced silicon and tape-out cost, and reduced bring-up effort for manufacturing, modularity, or flexibility to customers to choose a preferred configuration depending on a deployment scenario. In some aspects, users may select between increased transmission beamforming and MU-MIMO gains on a given band with a 2N×2N configuration or increased frequency bands with a two-N×N configuration (for example, with a first N×N component chip on a first frequency band or frequency channel and a second N×N component chip on a second frequency band or frequency channel).

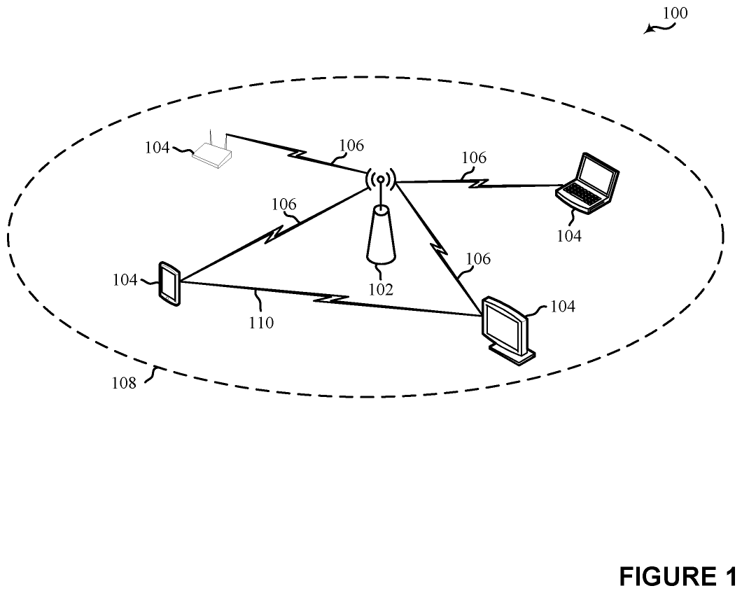

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As a result, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics, such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the physical (PHY) and medium access control (MAC) layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As a result, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

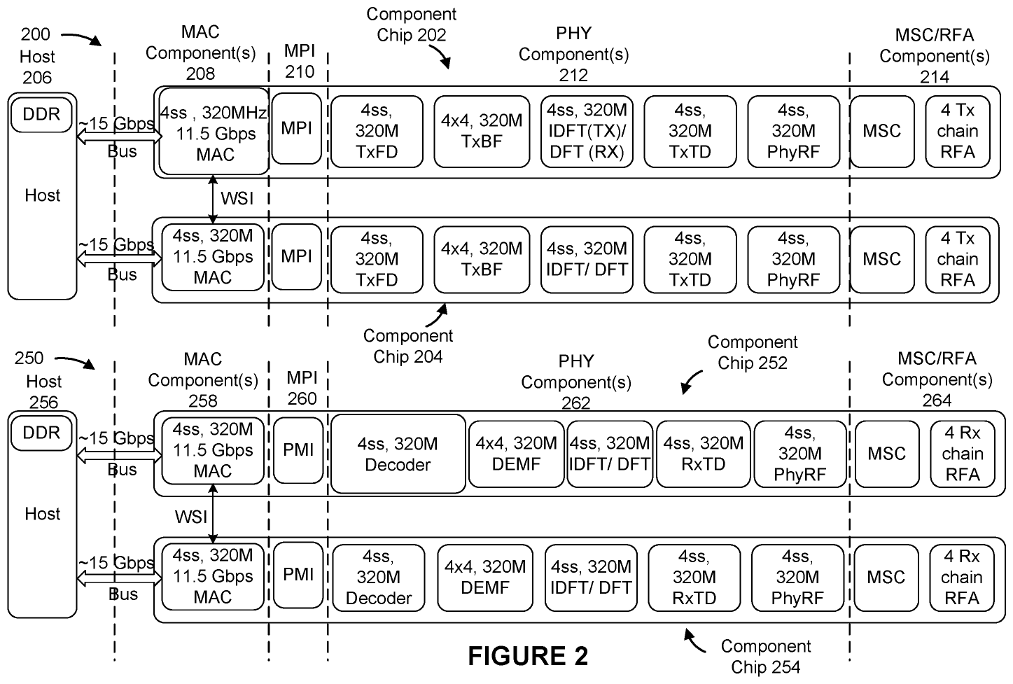

FIG. 2 illustrates an example 200 of a first component chip 202 for transmission and a second component chip 204 for transmission, and an example 250 of a third component chip 252 for reception and a fourth component chip 254 for reception. The first component chip 202 and the second component chip 204 may be included in a WCD, such as an AP or a STA. Similarly, the third component chip and the fourth component chip may be included in a WCD, such as an AP or a STA. The component chip 202 and the component chip 252 may be a single component chip, and the component chip 204 and the component chip 254 may be a single component chip such that each component chip may perform transmission and reception operations.

As shown in example 200, a WCD may include a host 206 that is capable of executing one or more applications including an application for wireless communication. For example, the host 206 may include storage, such as double data rate (DDR) random-access memory (RAM), which is shown in the accompanying figures as DDR. The storage may include computer-readable media that may be used to store instructions for providing information to, or receiving information from, the component chips 202, 204, 252, or 254 of FIG. 2.

The host 206 may be connected to the first component chip 202 with a first bus, such as a peripheral component interconnect express (PCIe) bus, among other examples. Any suitable bus may be used to couple the host 206 to the component chips in the following figures. In example 200, the host 206 may be coupled to the first component chip and to the second component chip with respective buses that each support 15 gigabits per second (Gbps) transfers.

The first component chip and the second component chip include medium access control (MAC) components 208. In example 200, the MAC component 208 of the first component chip supports 4 spatial streams with a bandwidth of 320 MHz and at a throughput of 11.5 Gbps. The MAC component 208 of the second component chip also supports 4 spatial streams with a bandwidth of 320 MHz and at a throughput of 11.5 Gbps. The MAC component 208 of the first component chip and the MAC component 208 of the second component chip may synchronize via a wireless serial interface (WSI).

The first component chip and the second component chip include MAC-to-physical-layer (PHY) interface (MPI) components 210. The MPI components 210 may pass information bits for a communication from the MAC layer to the PHY layer or from the PHY layer to the MAC layer. In some examples, the MPI component 210 may insert lower layer (PHY layer) elements for a data packet before passing the information bits to PHY components 212, or may remove the lower layer elements from a data packet before passing the information bits to the MAC component 208.

The PHY components 212 of each of the first component chip and the second component chip may include a frequency domain (FD) transmission (TxFD) component (hereinafter also referred to simply as a “TxFD”). The TxFD may perform encoding (for example, low-density parity-check (LDPC) encoding or binary convolutional coding (BCC) encoding, among other examples), interleaving, and stream parsing, among other examples. In example 200, each of the TxFDs may support 4 spatial streams at 320 MHz.

The PHY components 212 may include a transmission beamformer (TxBF). The TxBF may perform beamforming weights calculations. In this way, the TxBF may apply weights to different antennas to improve steering of beams (for example, forming a direction of the beams) toward a receiving WCD. In example 200, the TxFDs may support 4 spatial streams (4×4) at 320 MHz.

The PHY components 212 may include an inverse discrete Fourier transform (iDFT) block or a discrete Fourier transform (DFT) block (such as an inverse fast Fourier transform (iFFT) block or a fast Fourier transform (FFT) block). The iDFT may convert signals from a frequency domain to a time domain for transmission by antennas. The DFT may convert signals from the time domain to the frequency domain for decoding. In example 200, the iDFTs or DFTs may support 4 spatial streams at 320 MHz.

The PHY components 212 may include a time domain (TD) transmission (TxTD) component. The TxTD component may perform transmission time domain processing. In example 200, the TxTDs may support 4 spatial streams (4×4) at 320 MHz.

The PHY components 212 may include a PHY radio frequency (PHYRF) component. The PHYRF component may perform transmission power control (TPC) or Cals. In example 200, the PHYRF may support 4 spatial streams (4×4) at 320 MHz.

The first component chip and the second component chip include mixed signal components (MSC) and radio frequency (RF) analog (RFA) components (MSC/RFA components) 210. The MSC/RFA components 214 may include an MSC configured to process a signal in a digital domain and an analog domain, such as an analog-to-digital converter or a digital-to-analog converter. The MSC/RFA components 214 also include a set of transmission chains and RFAs. In example 200, the MSC/RFA components 214 include 4 transmission chains and associated RFAs. The 4 transmission chains may transmit or receive 4 streams for an associated component chip.

In example 200, the first component chip and the second component chip may be used to transmit the same 4 streams or may be used to transmit on different respective frequency channels. However, the first component chip and the second component chip are not configured to transmit different streams on the same frequency channel without causing too much interference to be decoded at a receiving WCD.

As shown in example 250, the component chip 252 and the component chip 254 may be used to receive 4 spatial streams. In example 250, the first component chip and the second component chip may be used to receive on different frequency channels. However, the first component chip and the second component chip are not configured to receive different streams on the same frequency channel based on different streams causing too much interference to be decoded at the WCD.

Example 250 shows a WCD that includes a host 256 that is configured with an application for communication. For example, the host 256 may include storage, such as DDR RAM, which is shown in the figure as DDR. The storage may include computer-readable media that may be used to store instructions for providing information to, or receiving information from, the component chips 202, 204, 252, or 254 of FIG. 2.

The host 256 may be connected to a first component chip 202 with a first bus, among other examples. Any suitable bus, such as a peripheral component interconnect express (PCIe) bus, may be used to couple a host to component chips. In example 250, the host 256 may be coupled to the first component chip and to the second component chip with respective buses that each support 15 Gbps transfers.

The first component chip and the second component chip include MAC components 258. In example 250, the MAC component 258 of the first component chip supports 4 spatial streams with a bandwidth of 320 MHz and at a throughput of 11.5 Gbps. The MAC component 208 of the second component chip also supports 4 spatial streams with a bandwidth of 320 MHz and at a throughput of 11.5 Gbps. The MAC component 208 of the first component chip and the MAC component 208 of the second component chip may synchronize via a WSI.

The first component chip and the second component chip include MPI components 260. The MPI components 260 pass information bits for a communication from the MAC layer to the PHY layer or from the PHY layer to the MAC layer. In some examples, the MPI component 260 may insert lower layer (PHY layer) elements of a data packet before passing the information bits to PHY components 262 or may remove the lower layer elements from a data packet before passing the information bits to the MAC component 258.

The PHY components 262 of the first component chip and the second component chip may include a frequency domain processor (shown in FIG. 2 as a decoder or de-interleaver (referred to herein as a decoder, intended to include a decoder, a de-interleaver, or both); however, other frequency domain processors may be used). The frequency domain processor may perform decoding (for example, LDPC or uplink decoding), de-interleaving, or stream de-parsing, among other examples. In example 250, the frequency domain processor may support 4 spatial streams at 320 MHz.

The PHY components 262 may include a demodulator (shown in FIG. 2 as a demodulator front end (DEMF); however, other demodulators may be used). The demodulator may perform demodulation or channel estimation, among other examples. In example 250, the demodulator may support 4 spatial streams (4×4) at 320 MHz.

The PHY components 262 may include an iDFT or a DFT. The iDFT may convert signals from a frequency domain to a time domain for transmission by antennas. The DFT may convert signals from the time domain to the frequency domain for decoding. In example 250, the iDFTs or DFTs may support 4 spatial streams at 320 MHz.

The PHY components 262 may include a reception time domain (RxTD) component. The RxTD component may perform reception time domain processing. In example 250, the RxTDs may support 4 spatial streams at 320 MHz.

The PHY components 262 may include a PHYRF component. The PHYRF component may perform transmission power control (TPC) or Cals. In example 200, the PHYRF may support 4 spatial streams (4×4) at 320 MHz.

The first component chip and the second component chip include MSC/RFA components 264. The MSC/RFA components 264 include an MSC configured to process a signal in a digital domain and an analog domain, such as an analog-to-digital converter or a digital-to-analog converter. The MSC/RFA components 264 also include a set of transmission chains and RFAs. In example 200, the MSC/RFA components 264 include 4 transmission chains and associated RFAs. The 4 transmission chains may transmit or receive 4 streams for an associated component chip.

As described herein, FIG. 2 is provided as an example. Other examples having more, fewer, or different components from those shown in FIG. 2 may be used to perform similar operations.

Typically, a WCD (such as an AP or STA) includes only a single communication chip for WLAN communications (for example, including a modem, a set of antennas, or a set of processing components). Some higher-end WCDs may include multiple communication chips to be able to communicate over the air with one or more WCDs. The communication chip may be configured with a quantity of antennas based on a planned usage of the WCD, cost constraints, or throughput gains desired for the WCD. For example, an 8×8 configuration (for example, where the communication chip is configured to communicate using up to 8 antennas with the other WCD having up to 8 antennas) improves diversity gain and range compared to a 4×4 configuration. Additionally or alternatively, an 8×8 configuration may improve multiple user (MU)-multiple-input multiple-output (MIMO) throughput (for uplink (UL)) compared to a 4×4 configuration. However, a cost of the 8×8 configuration may be significantly higher than a cost of the 4×4 configuration. As shown in FIG. 2, some WCDs may include multiple component chips that are configured to communicate using different frequency channels or to communicate duplications of a same set of streams. However, the multiple component chips are not configured to communicate different streams on a same frequency channel. In this way, the WCD is limited to communicating a quantity of streams, for communications with a single additional WCD, that is less than or equal to a quantity of antennas of a single communication chip of the WCD.

For these reasons, some enterprise users, with a priority of performance, may prefer an 8×8 configuration. However, some retail users or carrier users, with a priority of cost reduction, may prefer a 4×4 configuration. Manufacturers of communication chips may choose to manufacture an 8×8 configuration only (an unnecessarily expensive option for retail users and carrier users), to manufacture a 4×4 configuration only (failing to satisfy performance preferences of enterprise customers), or to manufacture both 4×4 and 8×8 configurations (with increased engineering and manufacturing costs, multiple tape-outs and multiple bring-up procedures for manufacturing).

Various aspects relate generally to a WCD, such as an access point, that includes multiple component chips that may be configured to work together as a partitioned chip having a capability to communicate using a quantity of spatial streams that exceeds a capacity of any one of the multiple component chips when operated independently. Some aspects more specifically relate to component chips having frequency domain components that support a first quantity of spatial streams in a frequency domain and having time domain components that support a second quantity of spatial streams in a time domain. The first quantity may be greater than the second quantity. In some examples, the first quantity of spatial streams may correspond to a quantity of spatial streams that are transmitted or received collectively by multiple component chips, and the second quantity of spatial streams may correspond to a quantity of spatial streams that are transmitted or received by each component chip individually. In this way, the frequency domain components of a component chip (for example, a master chip, a primary chip, a secondary chip, or a slave chip) may support processing of all spatial streams that the WCD communicates, and the time domain component may process only a subset of spatial streams.

Based on the time domain components, including RF antennas, processing only a subset of spatial streams, the component chip may have a reduced complexity, may have a reduced manufacturing cost, and may be used in additional implementations when compared to a component chip that supports processing of all spatial streams in the time domain and in the frequency domain. For example, the component chip may be a 4×4 component chip that can be used in devices that are intended to support only 4 spatial streams, or the component chip may be used along with one or more additional 4×4 component chips to support additional spatial streams. The component chip and the one or more additional component chips may be configured to communicate on a same frequency channel, such that an additional WCD may perceive the WCD a single 8×8 WCD, a single 12×12 WCD, a single 16×16 WCD, etc.

Particular aspects of the subject matter described in this disclosure can be implemented to realize one or more of the following potential advantages. In some examples, by supporting coupling of multiple component chips together, the described techniques can be used to reduce manufacturing costs associated with manufacturing multiple types of component chips with different numbers of antennas. Additionally or alternatively, by supporting coupling of multiple component chips together, the described techniques can allow a single configuration of component chips having N antennas to be used in applications with N, 2N, 3N, etc. combined antennas. In this way, the single configuration may be used to satisfy demands of different types of consumers and use cases, such as for retail customers, carrier customers, and enterprise customers with different priorities of cost and performance.

In this way, a WCD that has more than one component chip (for example, a 4×4 chip) may combine two component chips (for example, APs or STAs) to achieve performance of a 2N×2N component chip (also referred to as a partitioned component chip). The 2N×2N component chip may provide, as compared to a standard N×N architecture, increased transmission beamforming and MU-MIMO gain, increased range, reduced silicon and tape-out cost, and reduced bring-up effort for manufacturing, modularity, or flexibility to customers to choose a preferred configuration depending on a deployment scenario. In some aspects, users may select between increased TxBF and MU-MIMO gains on a given band with a 2N×2N configuration or increased frequency bands with a two-N×N configuration (for example, with a first N×N component chip on a first frequency band or frequency channel and a second N×N component chip on a second frequency band or frequency channel).

The accompanying figures describe details of both transmitter and receiver designs of a partitioned multi-component-chip architecture. Various options offer different levels of performance versus complexity and cost. Although the following figures may describe component chips in the context of 4×4 component chips for ease of description, each of the component chips should be interpreted as an N×N component chip, where 4 is an example of a value of N, but where N may be another positive integer. For example, the component chip may be used to form an effective 16×16 component chip (for example, AP or STA) using two 8×8 component chips (for example, APs or STAs). Additionally or alternatively, although the following figures may describe partitioned component chips as having a first component chip and a second component chip for ease of description, another integer number a of component chips may be used in a partitioned component chip to achieve an effective aN×aN configuration. For example, an effective 12×12 component chip may be formed out of three 4×4 component chips. In some other examples, one or more of the component chips may have a different number of antennas than another of the component chips. In some examples, the partitioned component chip may be configured to operate with a first aN×aN configuration for uplink communications and with a second bN×bN configuration for downlink communications.

The following figures also show modifications and buses that may be used to facilitate combining the component chips into a partitioned component chip that can communicate via a quantity of streams in a single frequency channel, with the quantity of streams being greater than a quantity of antennas of any single one of the component chips individually. For example, the modifications and buses may support a design of an 8×8 component chip from two 4×4 component chips (for example, APs or STAs) with additional modifications to support partitioning functionality.

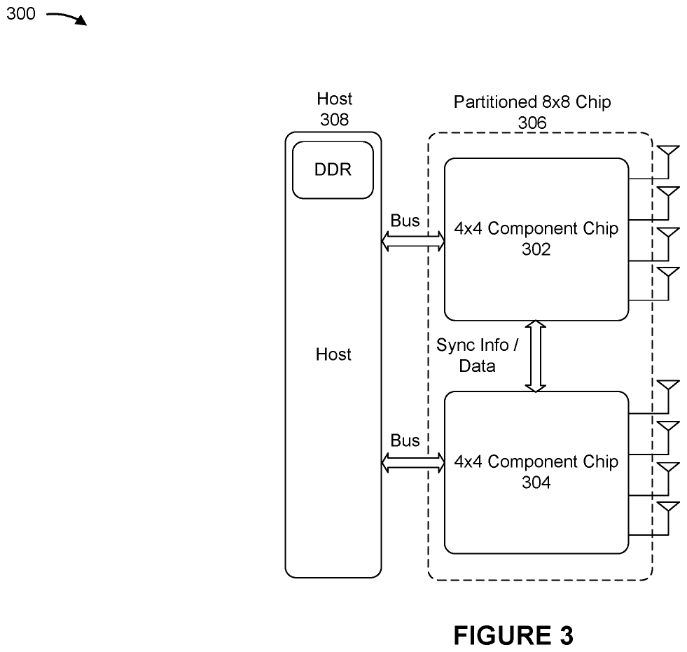

FIG. 3 illustrates an example 300 of a WCD having a first component chip 302 and a second component chip 304 coupled to form a partitioned component chip 306 that supports a quantity of spatial streams that is greater than a quantity supported by either of the first component chip 302 or the second component chip 304 individually.

As shown in FIG. 3, the WCD includes a host 308 that is capable of executing one or more applications including an application for wireless communication. For example, the host 308 may include storage, such as DDR RAM, which is shown in the figures as DDR. The storage may include computer-readable media that may be used to store instructions for providing information to, or receiving information from, the component chips of FIG. 3.

The host 308 may be connected to a partitioned chip 306 (shown as a partitioned 8×8 chip) that includes the first component chip 302 (shown as a 4×4 component chip) and the second component chip 304 (shown as a 4×4 component chip). The host 308 may be connected to the first component chip 302 with a first bus and to the second component chip 304 with a second bus. The first bus and the second bus may be a bus, among other examples. Any suitable bus, such as a PCIe bus, may be used to couple the host 308 to the component chips 302 and 304.

The first component chip 302 and the second component chip 304 may be coupled to each other using an additional bus. For example, the first component chip 302 and the second component chip 304 may be coupled to each other using a chip-to-chip (C2C) bus. The first component chip 302 and the second component chip 304 may transfer synchronization (sync) information and data via the additional bus. In this way, the first component chip 302 and the second component chip 304 may coordinate to form the partitioned chip 306 that supports a quantity of spatial streams that is greater than a quantity supported by the first component chip 302 or the second component chip 304 independently.

As described herein, FIG. 3 is provided as an example. Other examples having more, fewer, or different components from those shown in FIG. 3 may be used to perform similar operations.

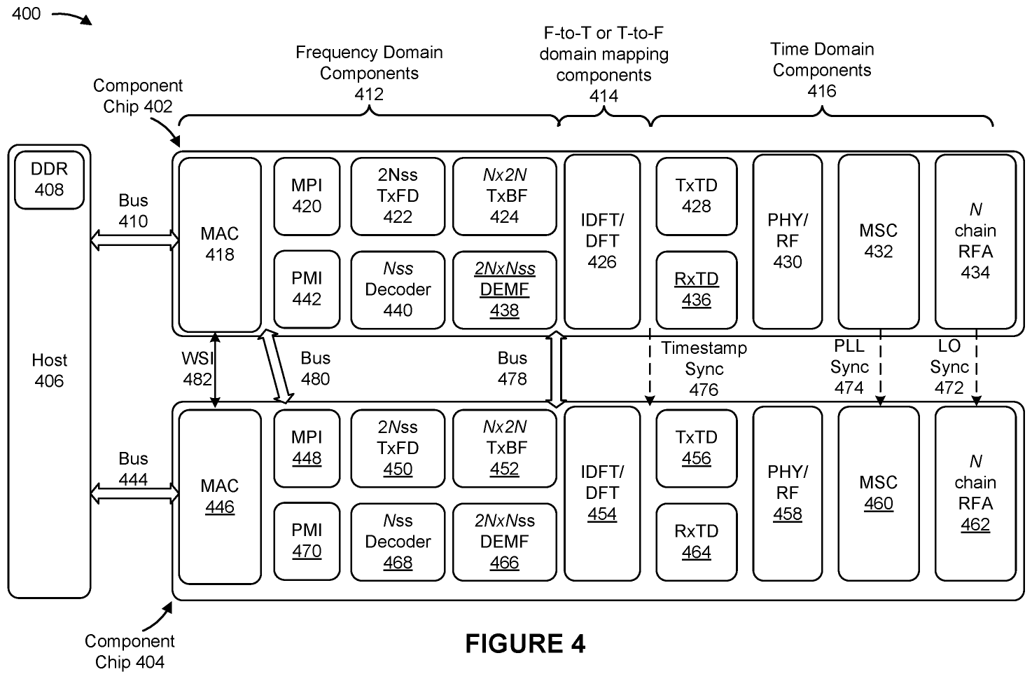

FIGS. 4-14 provide examples of component chips that may be used in the WCD of example 300.

FIG. 4 illustrates an example 400 of a first component chip 402 and a second component chip 404 that are coupled to be used as a partitioned component chip that supports a quantity of spatial streams that is greater than a quantity supported by one of the component chips individually. The component chips 402 and 404 may be included in a WCD, such as an AP or a STA.

As shown in example 400, a WCD may include a host 406 that is capable of executing one or more applications including an application for wireless communication. For example, the host 406 may include storage, such as DDR RAM, which is shown in the accompanying figures as DDR 408. The storage may include computer-readable media that may be used to store instructions for providing information to, or receiving information from, the component chips of FIG. 4.

The host 406 may be connected to a component chip 402 with a bus 410. In example 400, the host 406 may be coupled to the component chip 402 with a bus that supports about 15 Gbps or 30 Gbps transfers.

The component chip 402 may include frequency domain components 412, one or more frequency-to-time (F-to-T) or time-to-frequency (T-to-F) domain mapping components 414, and time domain components 416. In this way, the component chip 402 is able to process spatial streams in a frequency domain, convert the spatial streams for processing in a time domain, and then process the spatial streams in the time domain (for transmitted spatial streams). Similarly, the component chip 402 is able to process spatial streams in a time domain, convert the spatial streams for processing in a frequency domain, and then process the spatial streams in the frequency domain (for received spatial streams).

The frequency domain components 412 of the component chip 402 may include a MAC component 418. In example 400, the MAC component 418 of the component chip 402 may support 2N spatial streams with a bandwidth of M MHz. Additionally or alternatively, the component chip 402 may support N spatial streams with a bandwidth of 2M MHz. In some aspects, the component chip may switch between operating with 2N spatial streams and a bandwidth of M MHz and operating with N spatial streams and a bandwidth of 2M MHz.

The frequency domain components 412 of the component chip 402 may include a MAC to PHY interface (MPI) 420 for interfacing between the MAC 418 and a TxFD 422 for transmission of spatial streams. The TxFD 422 may support 2N spatial streams. For example, the TxFD 422 may process 2N spatial streams where the component chip 402 includes only N antennas and can transmit only N spatial streams.

The frequency domain components 412 of the component chip 402 may include a TxBF 424 that is configured as an N×2N TxBF. In this way the TxBF 424 may convert the 2N spatial streams to two sets of N streams. The time domain components 416 of the component chip 402 may process a first set of N spatial streams. In some aspects, the TxFD 422 and the TxBF 424 may be configured to support 2N spatial streams and a bandwidth of M MHz or to support N spatial streams and a bandwidth of 2M MHz. If N spatial streams are to be transmitted, a single component chip (component chip 402 or component chip 404) may be used to transmit the N spatial streams. This is possible based on each of the component chips having time domain components 416 that support all spatial streams to be transmitted. The MPI 420, the TxFD 422, and the TxBF 424 may be referred to as transmission frequency domain components.

The first set of N spatial streams may be provided to the F-to-T domain mapping component 414 of the component chip 402. The F-to-T domain mapping component may include an iDFT/DFT 426 that is configured to map the N spatial streams from the frequency domain to the time domain before passing the spatial streams to the time domain components 416. The time domain components 416 may include a TxTD 428, a PHY/RF 430, an MSC 432, and an N chain RFA 434 to transmit the N spatial streams. The TxTD 428, a PHY/RF 430, MSC 432, and N chain RFA 434 may be referred to as transmission time domain components.

The component chip 402 may also be configured to receive N spatial streams. The component chip 402 may use the time domain components 416 to receive the N spatial streams. For example, the time domain components 416 used to receive the N spatial streams may include the PHY/RF 430, MSC 432, and N chain RFA 434 along with an RxTD 436. The PHY/RF 430, MSC 432, N chain RFA 434, and the RxTD 436 may be referred to as reception time domain components. The time domain components 416 may process the N spatial streams before providing the N spatial streams to the T-to-F domain mapping component 414 (iDFT/DFT 426).

The T-to-F domain mapping component 414 may map the spatial streams from resources of the time domain to resources of the frequency domain for processing by the frequency domain components 412. The frequency domain components 412 may include reception-based components, such as a demodulator (shown as DEMF) 438, a decoder 440, a PHY-to-MAC interface (PMI) 470, and the MAC 418. In some aspects, the demodulator 438 may be configured to perform channel estimations based on all of the 2N spatial streams, based on receiving information associated with a second set of N spatial streams, and to select only the N spatial streams received via the time domain components 416 of the component chip 402. The decoder 440 may process the N spatial streams and provide the N spatial streams to the PMI 442, which is configured to provide the N spatial streams to the MAC 418. The demodulator 438, the decoder 440, the PMI 442, and the MAC 418 may be referred to as reception frequency domain components.

The described components may be included in the component chip 402. The component chip 402 may coordinate with a component chip 404 to operate as a partitioned chip configured to communicate 2N spatial streams. The component chip 402 may function as a primary or master chip and the component chip 404 may function as a secondary or slave chip. The component chip 404 may include similar components to those described in connection with component chip 402.

In some examples, the host 406 may be connected to a component chip 404 with a bus 444. For examples, the host 406 may be coupled to the component chip 404 with a bus that supports about 15 Gbps or 30 Gbps transfers. In some other examples, the bus may be disabled or omitted and the component chip 404 may receive the spatial streams (the same 2N spatial streams provided to the component chip 402) from the component chip 402 or may provide the spatial streams to the component chip 402.

The component chip 404 may include frequency domain components 412, one or more F-to-T or T-to-F mapping components 414, and time domain components 416. In this way, the component chip 404 is also able to process spatial streams in a frequency domain (if necessary), convert the spatial streams for processing in a time domain, and then process the spatial streams in the time domain (for transmitted spatial streams). Similarly, the component chip 404 is able to process spatial streams in a time domain, convert the spatial streams for processing in a frequency domain, and then process the spatial streams in the frequency domain (for received spatial streams if necessary).

The frequency domain components 412 of the component chip 404 may include a MAC component 446. In example 400, the MAC component 446 of the component chip 404 may support 2N spatial streams with a bandwidth of M MHz. Additionally or alternatively, the component chip 404 may support N spatial streams with a bandwidth of 2M MHz. In some aspects, the component chip may switch between operating with 2N spatial streams and a bandwidth of M MHz and operating with N spatial streams and a bandwidth of 2M MHz.

The frequency domain components 412 of the component chip 404 may include an MPI 448 for interfacing between the MAC component 446 and a TxFD 450 for transmission of spatial streams. The TxFD 450 may support 2N spatial streams. For example, the TxFD 450 may process 2N spatial streams where the component chip 404 includes only N antennas and can transmit only N spatial streams.

The frequency domain components 412 of the component chip 404 may include a TxBF 452 that is configured as an N×2N TxBF. In this way, the TxBF 452 may convert the 2N spatial streams to two sets of N streams. The time domain components 416 of the component chip 404 may process a second set of N spatial streams. In some aspects, the TxFD 450 and the TxBF 452 may be configured to support 2N spatial streams and a bandwidth of M MHz or to support N spatial streams and a bandwidth of 2M MHz.

The first set of N spatial streams may be provided to the F-to-T domain mapping component 414 of the component chip 404. The F-to-T domain mapping component may include an iDFT/DFT 454 that is configured to map the N spatial streams from the frequency domain to the time domain before passing the spatial streams to the time domain components 416. The time domain components 416 may include a TxTD 456, a PHY/RF 458, an MSC 460, and an N chain RFA 462 to transmit the N spatial streams.

The component chip 404 may also be configured to receive N spatial streams. The component chip 404 may use the time domain components 416 to receive the N spatial streams. For example, the time domain components 416 used to receive the N spatial streams may include the PHY/RF 458, MSC 460, and N chain RFA 462 along with an RxTD 464. The time domain components 416 may process the N spatial streams before providing the N spatial streams to the T-to-F domain mapping component 414 (iDFT/DFT 454).

The T-to-F domain mapping component 414 may map the spatial streams from resources of the time domain to resources of the frequency domain for processing by the frequency domain components 412. The frequency domain components 412 may include reception-based components, such as a demodulator (shown as DEMF) 466, a decoder 468, a PMI, and the MAC component 446. In some aspects, the demodulator 466 may be configured to perform channel estimations based on all of the 2N spatial streams, based on receiving information associated with a second set of N spatial streams, and to select only the N spatial streams received via the time domain components 416 of the component chip 402. The decoder 468 may process the N spatial streams and provide the N spatial streams to the PMI 470, which is configured to provide the N spatial streams to the MAC component 446.

As shown in FIG. 4, the component chip 402 may be coupled to the component chip 404 using one or more buses or other connections. For example, the N chain RFA 434 of the component chip 402 may be coupled to the N chain RFA 462 of the component chip 404 to perform local oscillator (LO) synchronization 472. For example, the component chip 402 may use a connection to provide information or commands for LO synchronization 472 to the N chain RFA 462. The LO synchronization 472 may improve alignment of frequency mapping for transmission and reception of multiple streams on a same frequency channel.

Additionally or alternatively, the MSC 432 may be coupled with the MSC 460 for the component chip 402 to provide information for phase-locked loop (PLL) synchronization 474 to the component chip 404. The PLL synchronization 474 may improve alignment in time resources for determining time resource boundaries. Further, the component chip 402 may provide information for timestamp synchronization 476 to the component chip 404. The timestamp synchronization 476 may improve timing synchronization among the time domain components 416.

In some aspects, the component chip 402 and the component chip 404 may be coupled using a bus 478. In some aspects, the bus 478 may include a C2C bus. The bus 478 may support providing output of the iDFT/DFT 454 to the demodulator 438 or providing output of the iDFT/DFT 426 to the demodulator 466 for processing, such as estimating a channel of the 2N spatial streams. In some aspects where both frequency domain components process spatial streams, the bus 478 may carry data from the component chip 402 to the component chip 404 and from the component chip 404 to the component chip 402. In some aspects where only frequency domain components 412 of the component chip 402 process spatial streams, the bus 478 may carry data only from the component chip 404 to the component chip 402.

In some aspects, the component chip 402 and the component chip 404 may be coupled using a bus 480. In some aspects, the bus 480 may include a C2C bus. The bus 480 may support providing output of the MAC 418 to the MPI 448 or providing output of the PMI 470 to the MAC 418. The MAC 418 and the MAC 446 may synchronize using a WSI 482.

As described herein, FIG. 4 is provided as an example. Other examples having more, fewer, or different components from those shown in FIG. 4 may be used to perform similar operations.

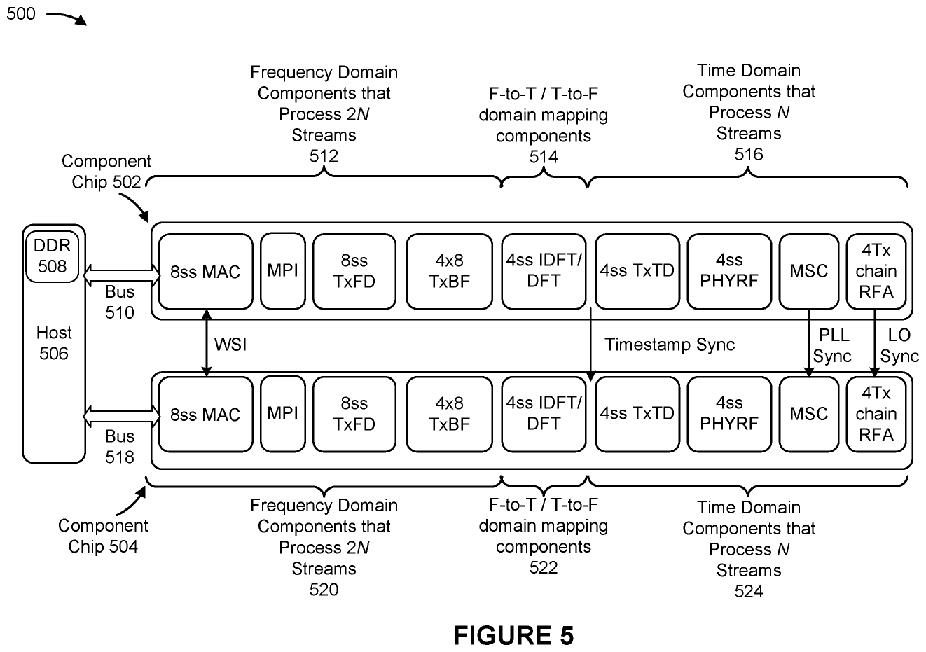

FIG. 5 illustrates an example 500 of a first component chip 502 and a second component chip 516 that are coupled to be used as a partitioned component chip that supports a transmission of a quantity of spatial streams that is greater than a quantity supported by one of the component chips individually. The component chip 502 and the component chip 504 may be included in a WCD, such as an AP or a STA.

As shown in example 500, a WCD may include a host 506 that is capable of executing one or more applications including an application for wireless communication. For example, the host 506 may include storage, such as DDR RAM, which is shown in the figure as DDR 508. The storage may include computer-readable media that may be used to store instructions for providing information to, or receiving information from, the component chips of FIG. 5.

The host 506 may be connected to a component chip 502 with a bus 510. In example 500, the host 506 may be coupled to the component chip 502 with a bus that supports about 30 Gbps transfers.

The component chip 502 may include frequency domain components 512 that process 2N spatial streams, one or more F-to-T or T-to-F domain mapping components 514, and time domain components 546 that process N spatial streams. In this way, the component chip 502 is able to process a full set of spatial streams in a frequency domain, convert a subset of the spatial streams for processing in a time domain, and then process the subset of the spatial streams in the time domain (for transmitted spatial streams) before transmitting the subset of the spatial streams.

The host 506 may be connected to a component chip 516 with a bus 518. In example 500, the host 506 may be coupled to the component chip 516 with a bus that supports about 30 Gbps transfers.

The component chip 516 may include frequency domain components 520, one or more F-to-T or T-to-F domain mapping components 522, and time domain components 524. In this way, the component chip 516 is able to process spatial streams in a frequency domain, convert the spatial streams for processing in a time domain, and then process a subset of the spatial streams in the time domain (for transmitted spatial streams) before transmitting the subset of the spatial streams.

The component chip 502 and the component chip 516 may be coupled using a set of one or more buses. For example, the component chip 502 may use the set of one or more buses to provide information for LO synchronization, PLL synchronization, timestamp synchronization, or WSI, among other examples.

In example 500, the host 506 may provide all 2N spatial streams (shown as 8ss) to each of the component chips 502 and 516. The frequency domain components 512 and 520 of the component chips 502 and 516 may process all 2N spatial streams, including using TxBFs (shown as 4×8 TxBFs) to pass different subsets of size N from the 2N spatial streams to respective time domain components 514. For example, a TxBF of the component chip 502 may send a first subset {1, 2, . . . , N} and a TxBF of the component chip 516 may send a second subset {N+1, N+2, . . . , 2N} from the set of 2N spatial streams to the time domain components 514 of the component chip 502 and component chip 516. The TxBFs of each of the component chips 502 and 516 provide the respective subsets of the 2N spatial streams to F-to-T domain mapping components 514 and 522. The F-to-T domain mapping component 514 is configured to provide the first subset of the 2N spatial streams to the time domain components 516 that process N spatial streams (a quantity of spatial streams of the first subset). The F-to-T domain mapping component 522 is configured to provide the second subset of the 2N spatial streams to the time domain components 524 that process N spatial streams (a quantity of spatial streams of the second subset).

In the example 500, each of the component chip 502 and the component chip 516 may perform data generation and beamforming weight calculation on all 2N (for example, 8) spatial streams. For example, each chip may generate all 2N streams of data in the frequency domain and calculate a 4×8 weights matrix to pass respective subsets of the 2N spatial streams to provide to the iDFTs (F-to-T domain mapping components 504 and 522, respectively) as input. The component chip 502 (for example, a master chip or a primary chip) may pass the upper 4 spatial streams (for example, chains) at the iDFT input (F-to-T domain mapping components 504) and the component chip 516 (for example, a slave chip or a secondary chip) may pass the lower 4 spatial streams to the (F-to-T domain mapping components 522). TxTD and PHYRF synchronization may be achieved through timestamp synchronization between the two chips, PLL synchronization, and LO synchronization.

In some examples, each of the MAC components of the component chips 502 and 516 may operate at about 23.1 Gbps, which may be lower than that supported by the buses 510 and 518. However, the component chips 502 and 516 may each operate with a 2M bandwidth.

Based on the component chip 502 and the component chip 516 coordinating (for example, with the WSI, timestamp synchronization, PLL synchronization, or the LO synchronization), each component chip may operate as if in a 2N×2N configuration in the frequency domain and may operate as if in an N×N configuration in the time domain. This may allow an associated WCD to communicate using more streams than if using each component chip individually.

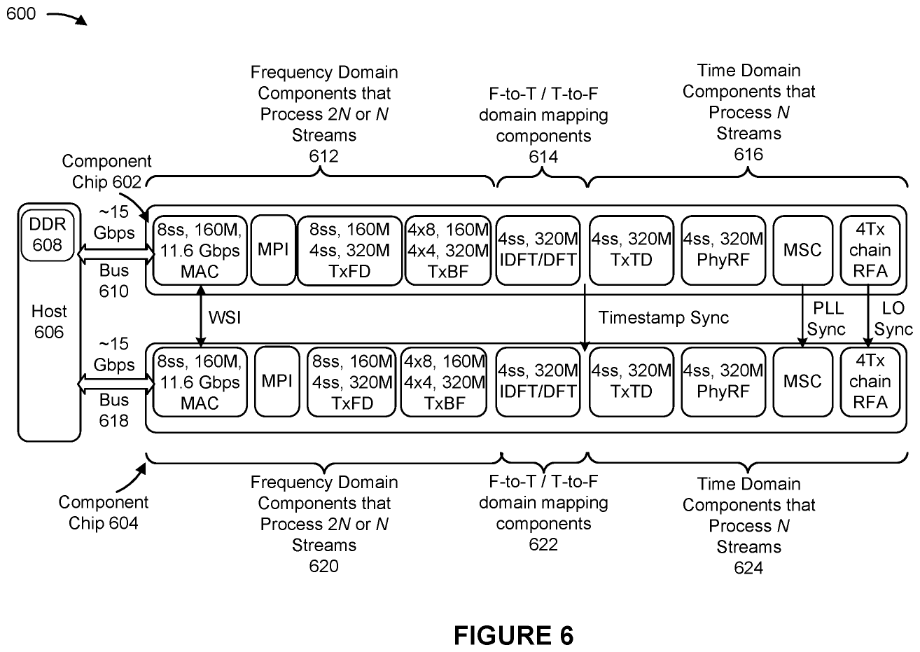

FIG. 6 illustrates an example 600 of a first component chip 602 and a second component chip 604 that are coupled to be used as a partitioned component chip that supports a transmission of a quantity of spatial streams that is greater than a quantity supported by one of the component chips 602 and 604 independently. The component chips may be included in a WCD, such as an AP or a STA.

As shown in example 600, a WCD may include components described in connection with FIGS. 2-5. For example, the WCD may include a host 606, DDR 608, a bus 610, frequency domain components 612, F-to-T or T-to-F domain mapping components 614, time domain components 616, a bus 618, frequency domain components 620, F-to-T or T-to-F domain mapping components 622, and time domain components 624. The component chip 602 and the component chip 604 may be coupled using a set of one or more buses as described in the context of FIGS. 3-5.

In example 600, the host 606 may be coupled to the component chip 602 and the component chip 604 with respective buses that support about 15 Gbps transfers. This is about half of the throughput supported in example 500. The frequency domain components 612 and 620 may each process 2N or N spatial streams. The F-to-T or T-to-F domain mapping components 614 and time domain components 616 that process N spatial streams. In this way, the component chips 602 and 604 are able to process a full set of spatial streams in a frequency domain, convert a subset of the spatial streams for processing in a time domain, and then process the subset of the spatial streams in the time domain (for transmitted spatial streams) before transmitting the subset of the spatial streams.

In example 600, the host 606 may provide all 2N spatial streams (shown as 8ss) to each of the component chips 602 and 604. The frequency domain components 612 and 620 of the component chips 602 and 604 may process all 2N spatial streams, including using TxBFs (shown as 4×8 TxBFs) to select different subsets of size N from the 2N spatial streams. For example, a TxBF of the component chip 602 may select a first subset {1, 2, . . . , N} and a TxBF of the component chip 604 may select a second subset {N+1, N+2, . . . , 2N} from the set of 2N spatial streams. The TxBFs of each of the component chips 602 and 604 provide the respective subsets of the 2N spatial streams to F-to-T domain mapping components 614 and 622. The F-to-T domain mapping component 614 is configured to provide a first subset of the 2N spatial streams to the time domain components 616 that process N spatial streams (a quantity of spatial streams of the first subset). The F-to-T domain mapping component 622 is configured to provide a second subset of the 2N spatial streams to the time domain components 624 that process N spatial streams (a quantity of spatial streams of the second subset) that are different from the N spatial streams processed by the time domain component 616.

In the example 600, each of the component chip 602 and the component chip 604 may perform data generation and beamforming weight calculations on all 2N (for example, 8) spatial streams. For example, each chip may generate all 2N of data in the frequency domain and calculate a 4×8 weights matrix to select respective subsets of the 2N spatial streams to provide to the iDFT as input. The component chip 602 (for example, a master chip or a primary chip) may select the upper 4 spatial streams (for example, chains) at the iDFT input, and the component chip 604 (for example, a slave chip or a secondary chip) may select the lower 4 spatial streams. TxTD and PHYRF synchronization may be achieved through timestamp synchronization between the two chips, PLL synchronization, and LO synchronization.

Each of the MAC components of the component chips 602 and 604 may operate at about 11.5 Gbps, as an example, which is lower than supported by the buses 610 and 618 and the MAC components of FIG. 5. In some aspects, the component chips 602 and 604 may be configured to operate as independent N×N chips with a bandwidth of 2M or may be configured to each operate with a bandwidth of M when operating as a partitioned chip that operates collectively as a 2N×2N chip.

In this way, each component chip may operate as if in a 2N×2N configuration in the frequency domain and may operate as if in an N×N configuration in the time domain. However, the component chips may have lower complexity and cost when compared to example 500.

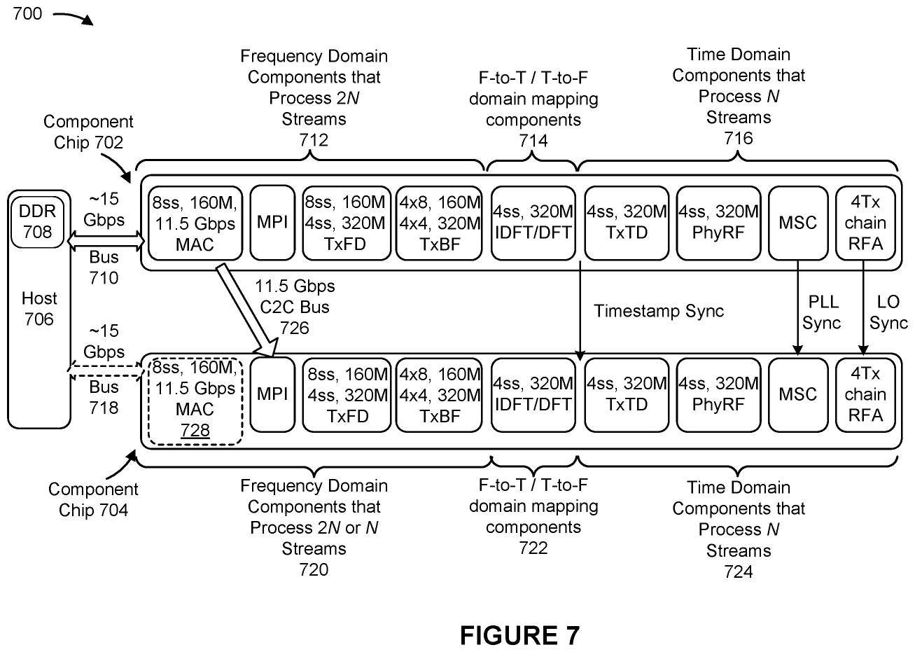

FIG. 7 illustrates an example 700 of a first component chip 702 and a second component chip 704 that are coupled to be used as a partitioned component chip that supports a transmission of a quantity of spatial streams that is greater than a quantity supported by one of the component chips individually. The component chips 702 and 704 may be included in a WCD, such as an AP or a STA.

As shown in example 700, a WCD may include components described in connection with FIGS. 2-5. For example, the WCD may include a host 706, DDR 708, a bus 710, frequency domain components 712, F-to-T or T-to-F domain mapping components 714, time domain components 716, a bus 718, frequency domain components 720, F-to-T or T-to-F domain mapping components 722, and time domain components 724. The component chip 702 and the component chip 704 may be coupled using a set of one or more buses as described in the context of FIGS. 3-5.

In example 700, the host 706 may be coupled to the component chip 702 and the component chip 704 with respective buses that support about 15 Gbps transfers.

Example 700 is similar to example 600, with a difference being an addition of a bus 728 (shown as a C2C bus 728) that couples a MAC component of the frequency domain components 712 to an MPI component of the frequency domain components 720. In example 700, the host 706 may not be connected to a component chip 704 as shown in FIGS. 5 and 6, or the bus 718 may be inactive. Additionally or alternatively, the MAC component 726 of the component chip 704 may be inactive or omitted from the component chip 704. Instead, a MAC component of the component chip 702 performs MAC processing for both of the component chip 702 and the component chip 704. The MAC of the component chip 702 may provide the spatial streams to an MPI of the component chip 704. Alternatively, an MPI of the component chip 702 may provide the spatial streams to a TxFD of the component chip 704, among other examples. The component chip 702 may provide the spatial streams via a bus 728 (shown as a C2C bus 728).

In the example 700, each of the component chip 702 and the component chip 704 may perform data generation and beamforming weight calculation on all 2N (for example, 8) spatial streams using only one MAC component (at the component chip 702). The MAC component of the component chip 702 shares data to be processed and transmitted by PHY components of the component chip 704. To share the data, the bus 728 may include a high-speed C2C bus. The bus 728 may use a C2C or Qlink interface for transmission and reception operations.

In this way, a processing or complexity load on the host 706 may be reduced based on using only one active bus to provide the spatial streams for transmission. Additionally, based on the MAC of the component chip 704 being inactive, no additional MAC synchronization may be needed. In some aspects, each component chip may operate as if in a 2N×2N configuration in the frequency domain and may operate as if in an N×N configuration in the time domain. However, the component chips may have lower complexity and cost when compared to example 500.

The MAC component of the component chip 702 may operate at about 11.5 Gbps, as an example, which is lower than supported by the bus 710 and the MAC components of FIG. 5. In some aspects, the component chips 702 and 704 may be configured to operate as independent N×N chips with a bandwidth of 2M or may be configured to each operate with bandwidth of M when operating as a partitioned chip that operates collectively as a 2N×2N chip.

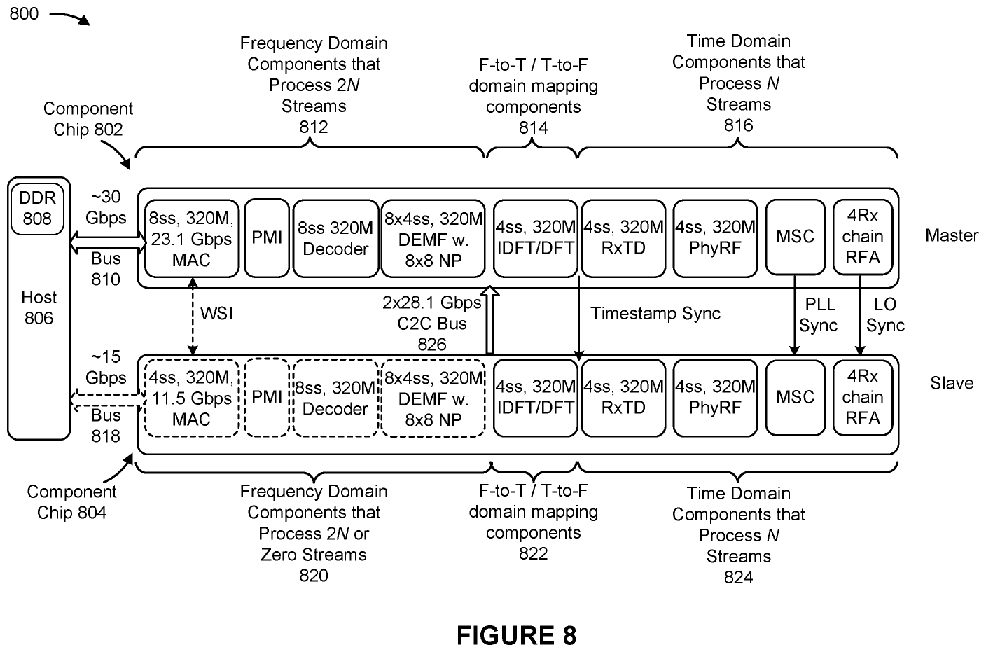

FIG. 8 illustrates an example 800 of a first component chip 802 and a second component chip 804 that are coupled to be used as a partitioned component chip that supports a reception of a quantity of spatial streams that is greater than a quantity supported by one of the component chips individually. The component chips 802 and 804 may be included in a WCD, such as an AP or a STA.

As shown in example 800, a WCD may include a host 806, DDR 808, a bus 810, frequency domain components 812 that process 2N spatial streams, one or more F-to-T or T-to-F domain mapping components 814, and time domain components 816 that process N spatial streams. In this way, the component chip 802 is able to process a subset of spatial streams received via the time domain components 816, convert the subset of the spatial streams for processing in the frequency domain, and process a full set of spatial streams in the frequency domain after receiving an additional subset of the spatial streams from the component chip 804.

The component chip 804 may include a bus 818, frequency domain components 820, one or more F-to-T or T-to-F domain mapping components 822, and time domain components 824. The component chip 804 is able to process spatial streams in a frequency domain, convert the spatial streams for processing in a time domain, and then process a subset of the spatial streams in the time domain (for transmitted spatial streams) if operating independently from the component chip 802.

In example 800, the host 806 may not be connected to a component chip 804 as shown in FIGS. 5 and 6, or the bus 818 may be inactive. In this way, the frequency domain components of the component chip 804 may be inactive or omitted from the component chip 804. Instead, the frequency domain components 812 of the component chip 802 perform frequency domain processing for both of the component chip 802 and the component chip 804, and the frequency domain components 820 may be inactive or omitted. The frequency domain components 812 may receive a subset of spatial streams from the time domain components 816 of the component chip 802 and a different subset of the spatial streams from the time domain components 824 of the component chip 802. For example, a demodulator of the frequency domain components 812 may receive a subset of the spatial streams from the component chip 804, as received via the time domain components 824 of the component chip 804, via the F-to-T domain mapping component 822. In some aspects, the frequency domain components 812 may receive the subset of spatial streams from the component chip 804 via a bus 826 (shown as a C2C bus 826).

The component chip 802 and the component chip 804 may be coupled using a set of one or more additional buses for LO synchronization, PLL synchronization, timestamp synchronization, or WSI, among other examples.

In example 800, the frequency domain components 812 of the component chip 802 may process all 2N spatial streams, and time domain components 916 and 924 of each of the component chips 802 and 804 may receive and process only a subset of the 2N spatial streams, and each component chip does not need to be manufactured with 2N reception chains and antennas.

In the example 800, two N×N PHYs that are configured to operate with a 2M bandwidth with a 2N×2N (for example, 8×8) null projection and 8 spatial streams demodulator on the component chip 802 are configured as a master or primary chip and a secondary chip. In an example operation, a DFT output of the T-to-F domain mapping component 822 is shared from the component chip 804 to the component chip 802 for processing in the frequency domain. In an example application, the bus 826 may have a required bus throughput (for example, 28.1 Gbps with one 3/4-lane PCIe 4.0 or equivalent for uni-directional data sharing from the component chip 804 to the component chip 802). The component chip 802 implements a 2N×2N null projection followed by a 2 N×N maximum-likelihood detector (ML) and 2N decoder.

In some aspects, the WCD may be configured to operate the component chip 802 and the component chip 804 as independent N×N chips or to operate the component chip 802 and the component chip 804 as independent 2N×2N chips. In some aspects, the WCD may be reconfigurable to change between N×N operation and 2N×2N operation.

The MAC component of the component chip 802 may operate at about 23.1 Gbps, as an example, which is lower than supported by the bus 810.

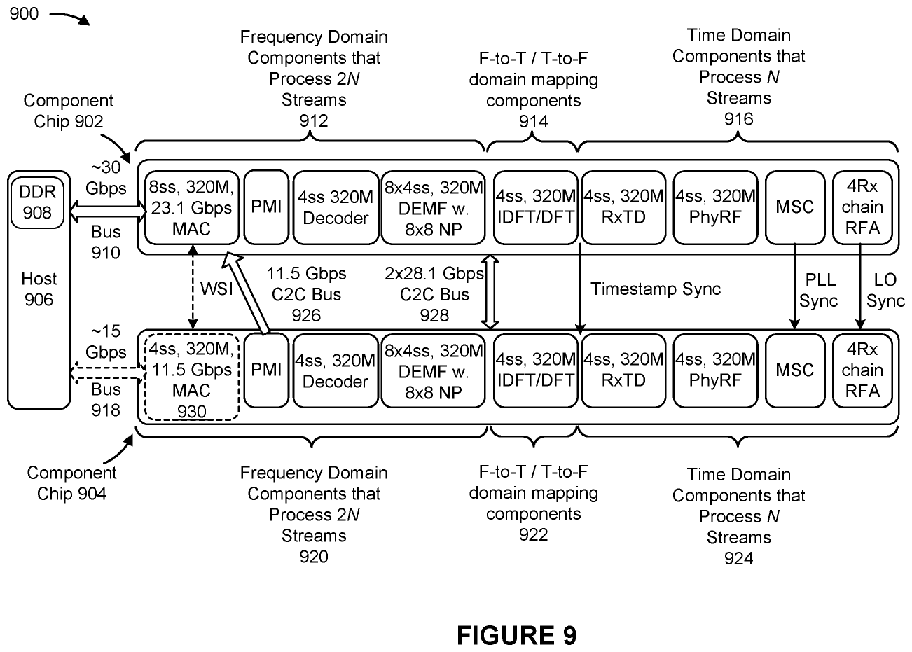

FIG. 9 illustrates an example 900 of a first component chip 902 and a second component chip 904 that are coupled to be used as a partitioned component chip that supports a reception of a quantity of spatial streams that is greater than a quantity supported by one of the component chips individually. The component chips 902 and 904 may be included in a WCD, such as an AP or a STA.

As shown in example 900, a WCD may include a host 906, DDR 908, a bus 910 (that supports about 30 Gbps transfers, for example), frequency domain components 912 that process 2N spatial streams, one or more F-to-T or T-to-F domain mapping components 914, and time domain components 916 that process N spatial streams. In this way, the component chip 902 is able to process a subset of spatial streams received via the time domain components 916, convert the subset of the spatial streams for processing in the frequency domain, and process a full set of spatial streams in the frequency domain after receiving an additional subset of the spatial streams from the component chip 904.

The component chip 904 may include a bus 918, frequency domain components 920, one or more F-to-T or T-to-F domain mapping components 922, and time domain components 924. The component chip 904 is able to process spatial streams in a frequency domain, convert the spatial streams for processing in a time domain, and then process a subset of the spatial streams in the time domain (for transmitted spatial streams) if operating independently from the component chip 902.

As shown in FIG. 9, a demodulator may process all spatial streams to perform channel estimation and demodulation of a selected subset of the set of spatial streams. The demodulator may be configured to provide the selected subset of the set of spatial streams to a decoder that processes the selected subset of the set of spatial streams. In this way, the frequency domain components 912 may process the 2N spatial streams without each of the frequency domain components 912 being configured to process all 2N spatial streams.

In example 900, the host 906 may not be connected to a component chip 904 as shown in FIGS. 5 and 6, or the bus 918 may be inactive. In this way, a MAC component 930 of the component chip 904 may be inactive or omitted from the component chip 904. Instead, a MAC component of the component chip 902 may be configured to perform MAC processing for both of the component chip 902 and the component chip 904. The MAC component of the component chip 902 may receive a subset of spatial streams from a PMI of the frequency domain components 920 of the component chip 904 that is a different subset of spatial streams from a PMI of the frequency domain components 912. In some aspects, the MAC component of the component chip 902 may receive the subset of spatial streams from the component chip 904 via a bus 926 (shown as a C2C bus 926). In some aspects, an additional bus 928 (shown as a C2C bus 928) may be configured to provide bi-directional outputs of DFTs of the component chip 902 and 904 to support demodulation and decoding on both component chips 902 and 904. For example, based on providing outputs of the DFTs to each component chip, the component chips may perform improved channel estimation and demodulation.

In the example 900, two N×N PHYs may operate at 2M bandwidth with a 2N×2N null projection and N spatial streams demodulators on each chip. DFT output may be shared bi-directionally between both component chips to support demodulation and decoding on both component chips. In an example scenario, the bus 926 may have a required bus throughput (for example, 2×28.1 Gbps with two 3/4-lane PCIe 4.0 or equivalent). Each component chip may implement a 2N×2N null projection and select a subset of the set of spatial streams (for example, upper or lower N chains). In some aspects, the bus 926 may have a required throughput (for example, 11.5 Gbps with one 1-lane PCIe 4.0 or equivalent).

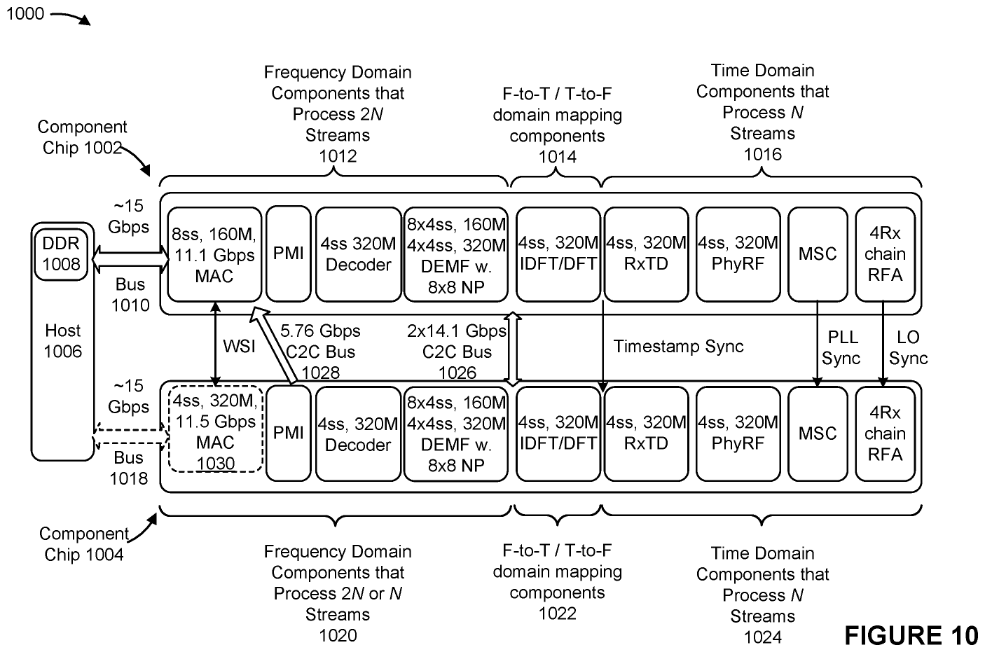

FIG. 10 illustrates an example 1000 of a first component chip 1002 and a second component chip 1004 that are coupled to be used as a partitioned component chip that supports a reception of a quantity of spatial streams that is greater than a quantity supported by one of the component chips individually. The component chips 1002 and 1004 may be included in a WCD, such as an AP or a STA.

As shown in example 1000, a WCD may include a host 1006, DDR 1008, a bus 1010 (that supports about 15 Gbps transfers, for example), frequency domain components 1012 that process 2N spatial streams, one or more F-to-T or T-to-F domain mapping components 1014, and time domain components 1016 that process N spatial streams. In this way, the component chip 1002 is able to process a subset of spatial streams received via the time domain components 1016, convert the subset of the spatial streams for processing in the frequency domain, and process a full set of spatial streams in the frequency domain after receiving an additional subset of the spatial streams from the component chip 1004.

The component chip 1004 may include a bus 1018, frequency domain components 1020, one or more F-to-T or T-to-F domain mapping components 1022, and time domain components 1024. The component chip 1004 is able to process spatial streams in a frequency domain, convert the spatial streams for processing in a time domain, and then process a subset of the spatial streams in the time domain (for transmitted spatial streams) if operating independently from the component chip 1002.

In contrast from example 900, a supported bandwidth may be reduced (for example, from 320 MHz to 160 MHz) for processing by the MAC of the frequency domain components 1012 when operating in coordination with the component chip 1004. In some aspects, an additional bus 1026 may be configured to provide bi-directional outputs of DFTs of the component chip 1002 and 1004 to support demodulation and decoding on both component chips 1002 and 1004. The additional bus 1026 may have a reduced bandwidth (for example, bi-directional bandwidth of 14.1 Gbps) for sharing DFT output between the component chips 902 and 904.

In an example scenario, a bus 1028 (similar to the bus 926) may have a required bus throughput (for example, 2×14.1 Gbps with two 3/4-lane PCIe 4.0 or equivalent). Each component chip may implement a 2N×2N null projection and select a subset of the set of spatial streams (for example, upper or lower N chains). In some aspects, the bus 1026 may have a required throughput (for example, 5.76 Gbps with one 1-lane PCIe 4.0 or equivalent).

The MAC component of the component chip 1002 may operate at about 11.5 Gbps, as an example, which is lower than supported by the bus 1010 and lower than the MAC of FIG. 9. However, the component chips may have lower complexity and cost when compared to example 900.

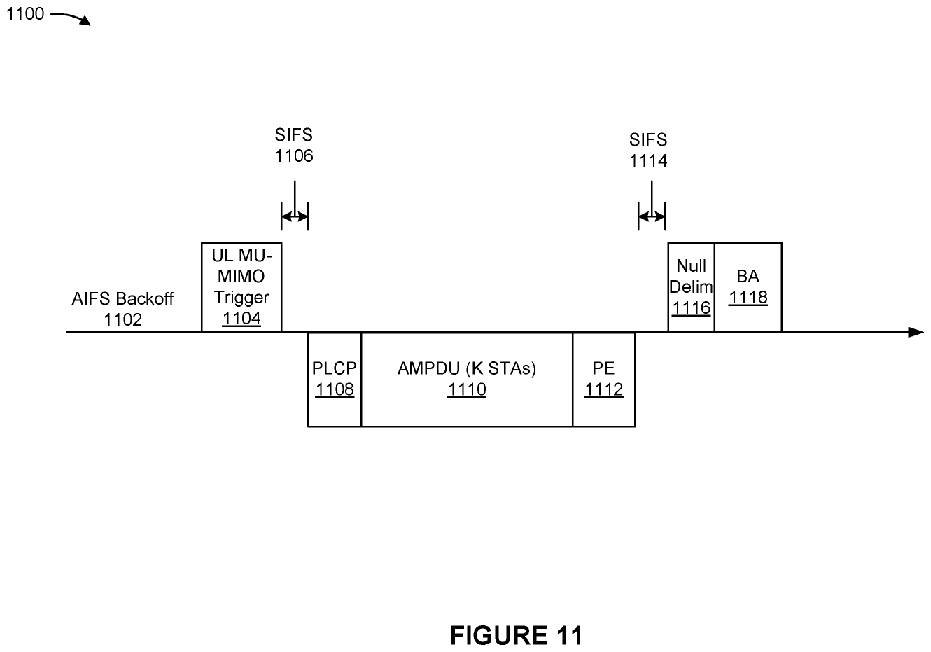

FIG. 11 shows a protocol 1100 for providing data between component chips, as described in the context of the aspects described herein. In the context of FIG. 11, a STA may communicate with an AP in a wireless network.

As shown in FIG. 11, and by reference number 1102, an arbitration inter-frame space (AIFS) backoff may separate a previous frame from a current frame. An AP may transmit an uplink multiple user (MU)-multiple-input multiple-output (MIMO) trigger 1104 that indicates that a message is to be transmitted to the AP from K STAs. A short inter-frame spacing (SIFS) 1106 may separate the UL MU-MIMO trigger 1104 from a response from the K STAs.

The response from the K STAs may include a physical layer convergence protocol (PLCP) portion 1108 (e.g., an 801.11be PLCP header). The PLCP portion 1108 may be followed by an aggregate MAC protocol data unit (A-MPDU) communication 1110 for K STAs and a packet extension (PE) portion 1112. The response from the K STAs may include an SIFS 1114.

Based on the AP using a partitioned chip, as described herein, DFT output may share latency between chips. The AP may compensate for the shared latency by pre-padding an acknowledgment message. For example, the AP may include a null delimiter (null delim) 1116 as dummy data before indicating a block acknowledgment (BA) 1118, such as a MAC BA. In this way, the acknowledgment message may begin after the SIFS 1114 without delay, which may comply with a configuration of an associated network (for example, in a communication standard). For example, the IEEE specification may mandate that a MAC BA 1118 must be sent after the SIFS 1114 immediately after receiving an uplink packet, but due to the increased latency from receiving with a partitioned chip, the AP may be unable to generate and prepare the MAC BA for sending after the SIFS 1114, so the AP may begin transmitting dummy data until actual data is ready for the BA 1118.

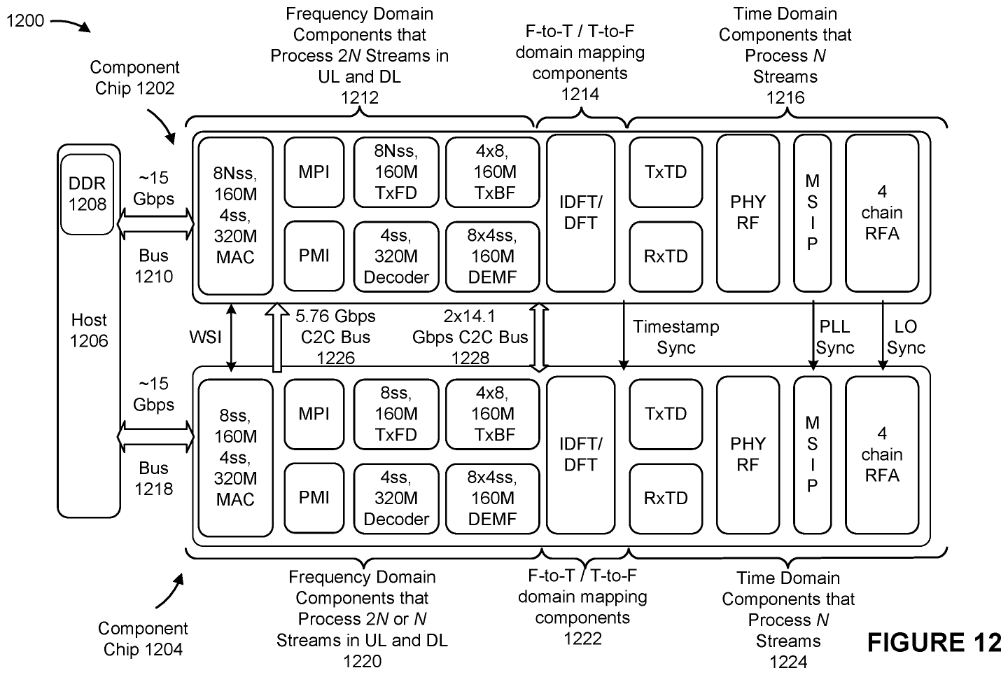

FIG. 12 illustrates an example 1200 of a first component chip 1202 and a second component chip 1204 that are coupled to be used as a partitioned component chip that supports a reception of a quantity of spatial streams that is greater than a quantity supported by one of the component chips individually. The component chips 1202 and 1204 may be included in a WCD, such as an AP or a STA.

As shown in example 1200, a WCD may include a host 1206 that may include storage, such as DDR 1208, a bus 1210 (for example, that supports about 15 Gbps transfers), frequency domain components 1212 that process 2N spatial streams for uplink or downlink, one or more F-to-T or T-to-F domain mapping components 1214, and time domain components 1216 that process N spatial streams in uplink or downlink.

In some aspects, the frequency domain components 1212 may include a set of uplink components (for example, MPI, TxFD, or TxBF) and a second of downlink components (for example, PMI, decoder, or demodulator). In some aspects, time domain components 1216 may include a downlink component (for example, TxTD) and an uplink component (RxTD). As shown in FIG. 12, the decoder may operate on only N spatial streams (shown as 4 spatial streams) even when the frequency domain components 1212 process 2N (shown as 8) spatial streams. As further shown in FIG. 12, the frequency domain components 1212 may be configured to communicate using 2N spatial streams at M bandwidth or using N spatial streams at 2M bandwidth.

The WCD may include a bus 1218 (for example, that supports about 15 Gbps transfers), frequency domain components 1220 that process 2N spatial streams for uplink or downlink, one or more F-to-T or T-to-F domain mapping components 1222, and time domain components 1224 that process N spatial streams in uplink or downlink.

In some aspects, the frequency domain components 1220 may include a set of uplink components (for example, MPI, TxFD, or TxBF) and a second of downlink components (for example, PMI, decoder, or demodulator). In some aspects, time domain components 1224 may include a downlink component (for example, TxTD) and an uplink component (RxTD). As shown in FIG. 12, the decoder may operate on only N spatial streams (shown as 4 spatial streams) even when the frequency domain components 1220 process 2N (shown as 8) spatial streams. As further shown in FIG. 12, the frequency domain components 1220 may be configured to communicate using 2N spatial streams at M bandwidth or using N spatial streams at 2M bandwidth.

A MAC component of the component chip 1202 may receive a subset of spatial streams from a PMI of the frequency domain components 1220 of the component chip 1204 that is a different subset of spatial streams from a PMI of the frequency domain components 1212. In some aspects, the MAC component of the component chip 1202 may receive the subset of spatial streams from the component chip 1204 via a bus 1226 (shown as a C2C bus 1226). In some aspects, an additional bus 1228 (shown as a C2C bus 1228) may be configured to provide bi-directional outputs of DFTs of the component chip 1202 and 1204 to support demodulation and decoding on both component chips 1202 and 1204. For example, based on providing outputs of the DFTs to each component chip, the component chips may perform improved channel estimation and demodulation. In an example scenario, the bus 1228 may have a required bus throughput (for example, 2×14.1 Gbps with two 3/4-lane PCIe 4.0 or equivalent). Each component chip may implement a 2N×2N null projection and select a subset of the set of spatial streams (for example, upper or lower N chains). In some aspects, the bus 1226 may have a required throughput (for example, 5.76 Gbps with one 1-lane PCIe 4.0 or equivalent).

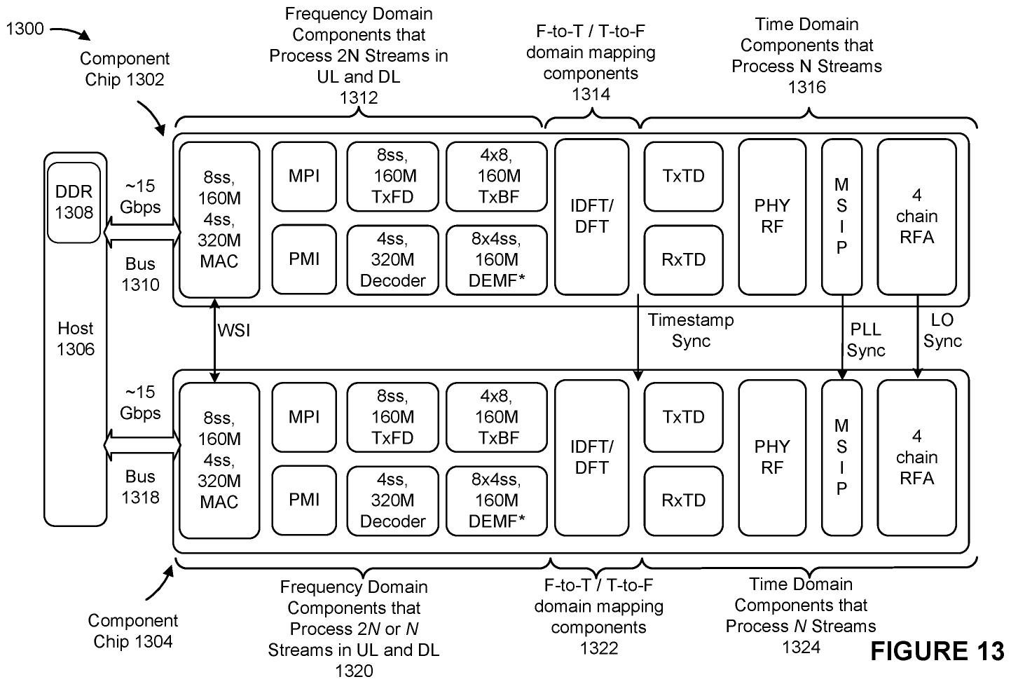

FIG. 13 illustrates an example 1300 of a first component chip 1302 and a second component chip 1304 that are coupled to be used as a partitioned component chip that supports a reception of a quantity of spatial streams that is greater than a quantity supported by one of the component chips individually. The component chips 1302 and 1304 may be included in a WCD, such as an AP or a STA. In example 1300, the component chips may be configured to transmit using 2N spatial streams and to receive using only N spatial streams. In this way, the WCD may have reduced cost or complexity relative to manufacturing the WCD with multiple buses, such as C2C buses with relatively high throughput requirements.

As shown in example 1300, a WCD may include a host 1306, DDR 1308, a bus 1310 (e.g., that supports about 15 Gbps transfers), frequency domain components 1312 that process 2N spatial streams for uplink or downlink, one or more F-to-T or T-to-F domain mapping components 1314, and time domain components 1316 that process N spatial streams in uplink or downlink.

In some aspects, the frequency domain components 1312 may include a set of uplink components (for example, MPI, TxFD, or TxBF) and a second of downlink components (for example, PMI, decoder, or demodulator). In some aspects, time domain components 1316 may include a downlink component (for example, TxTD) and an uplink component (RxTD). As shown in FIG. 13, the decoder may operate on only N spatial streams (shown as 4 spatial streams) even when the frequency domain components 1312 process 2N (shown as 8) spatial streams. As further shown in FIG. 13, the frequency domain components 1312 may be configured to communicate using 2N spatial streams at M bandwidth or using N spatial streams at 2M bandwidth.

The host 1306 may be connected to a component chip 1304 with a bus 1318. In example 1300, the host 1306 may be coupled to the component chip 1304 with a bus that supports about 15 Gbps transfers.

The component chip 1304 may include frequency domain components 1320 that process 2N spatial streams for uplink or downlink, one or more F-to-T or T-to-F domain mapping components 1322, and time domain components 1324 that process N spatial streams in uplink or downlink.

In some aspects, the frequency domain components 1320, the one or more F-to-T or T-to-F domain mapping components 1322, and time domain components 1324 may include similar components to those described in the context of frequency domain components 1312, one or more F-to-T or T-to-F domain mapping components 1314, and time domain components 1316 of the component chip 1302.

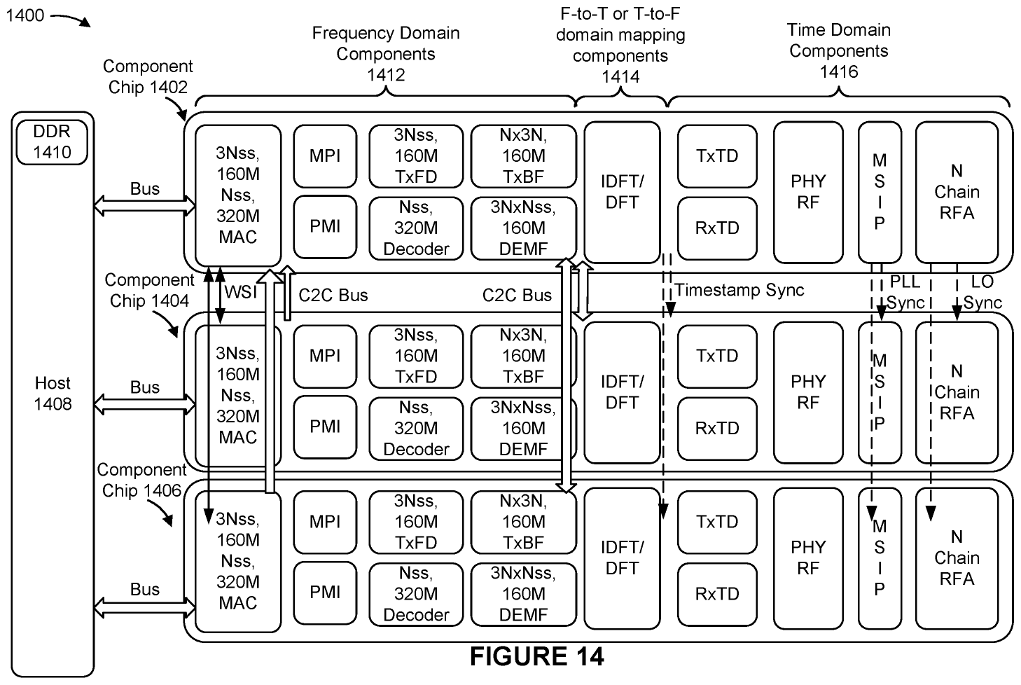

FIG. 14 illustrates an example 1400 of a first component chip 1402, a second component chip 1404, and a third component chip 1406 that are coupled to be used as a partitioned component chip that supports communication of a quantity of spatial streams that is greater than a quantity supported by one of the component chips individually. The component chips may be included in a WCD, such as an AP or a STA. In example 1400, the component chips 1402, 1404, and 1406 may be configured to communicate using aN spatial streams based on forming a partitioned component chip by coordinating and transferring data and information for synchronization among the component chips.

Example 1400 shows how more than two component chips may be used as component chips to communicate using a quantity of spatial streams that is greater than a quantity supported by one of the component chips individually. As shown in FIG. 14, a primary or master component chip may provide information (such as data or synchronization information) to or receive information from other component chips to coordinate communications.

As shown in example 1400, a WCD may include a host 1408, DDR 1410, and component chips 1402, 1404, and 1406. Example 1400 shows only 3 component chips; however, more than three component chips may be used in a similar arrangement. In some aspects, the component chip 1402 may be a master or primary component chip that provides synchronization information to the other component chips 1404 and 1406. Similarly, the component chip 1402 may receive information from the other component chips 1404 and 1406 or may provide information to the other component chips 1404 or 1406.

Although shown with each of the component chips coupled to the host 1408 via buses, some configurations and arrangements may reduce a quantity of active buses between the host 1408 and the component chips 1402, 1404, and 1406. For example, as shown in FIGS. 7, 8, 9, and 10, one or more of the component chips 1404 or 1406 may 1406 may have an inactive or omitted bus between the component chips 1404 or 1406 and the host 1408. In some aspects, the one or more component chips 1404 or 1406 may rely instead on providing or receiving information via a bus between the one or more component chips 1404 or 1406 and the component chip 1402, which maintains a bus for transferring information between the component chip 1402 and the host 1408.

The component chips 1402, 1404, and 1406 may include frequency domain components 1412 that process 3N (or aN, if using a component chips) spatial streams, one or more F-to-T or T-to-F domain mapping components 1414, and time domain components 1416 that process N spatial streams. In this way, the component chips 1402, 1404, and 1406 are able to process a full set of spatial streams in a frequency domain, convert a subset of the spatial streams for processing in a time domain, and then process the subset of the spatial streams in the time domain (for transmitted spatial streams) before transmitting the subset of the spatial streams. Similarly, the component chips 1402, 1404, and 1406 are able to process spatial streams in a time domain, convert the spatial streams for processing in a frequency domain, and then process the spatial streams in the frequency domain (for received spatial streams).

In example 1400, the host 1408 may provide all 3N spatial streams to each of the component chips 1402, 1404, and 1406. The frequency domain components 1412 of the component chips 1402, 1404, and 1406 may process all 3N spatial streams, including using TxBFs (shown as N×3N TxBFs) to select different subsets of size N from the 3N spatial streams. For example, a TxBF of the component chip 1402 may select a first subset {1, 2, . . . , N}, a TxBF of the component chip 1404 may select a second subset {N+1, N+2, . . . , 2N}, and a TxBF of the component chip 1406 may select a third subset {2N+1, 2N+2, . . . , 3N} from the set of 3N spatial streams. The TxBFs of each of the component chips 1402, 1404, and 1406 may provide the respective subsets of the 3N spatial streams to F-to-T domain mapping components 1414. The F-to-T domain mapping component 1414 of the component chip 1402 is configured to provide a first subset of the 3N spatial streams to the time domain components 1416 that process a first set of N spatial streams. The F-to-T domain mapping component 1414 of the component chip 1404 is configured to provide a second subset of the 3N spatial streams to the time domain components 1416 of the component chip 1404 that process a second set of N spatial streams. The F-to-T domain mapping component 1414 of the component chip 1406 is configured to provide a third subset of the 3N spatial streams to the time domain components 1416 of the component chip 1406 that process a third set of N spatial streams.

In example 1400, each of the component chips 1402, 1404, and 1406 may 1406 may perform data generation and beamforming weight calculation on all 3N spatial streams. For example, each chip may generate all 3N spatial streams of data in the frequency domain and calculate an N×3N weights matrix to select respective subsets of the 3N spatial streams to provide to the iDFT as input. The component chip 1402 (for example, a master chip or a primary chip) may select the upper N spatial streams (for example, chains) at the iDFT input, component chip 1404 may select the middle N spatial streams, and the component chip 1406 may select the lower N spatial streams. TxTD and PHYRF synchronization may be achieved through timestamp synchronization between the three chips, PLL synchronization, and LO synchronization.

In this way, each component chip may operate as if in a 3N×3N configuration in the frequency domain and may operate as if in an N×N configuration in the time domain. This may reduce cost and complexity of each of the component chips by not reducing a quantity of antennas, transmission chains, and reception chains of the component chips.

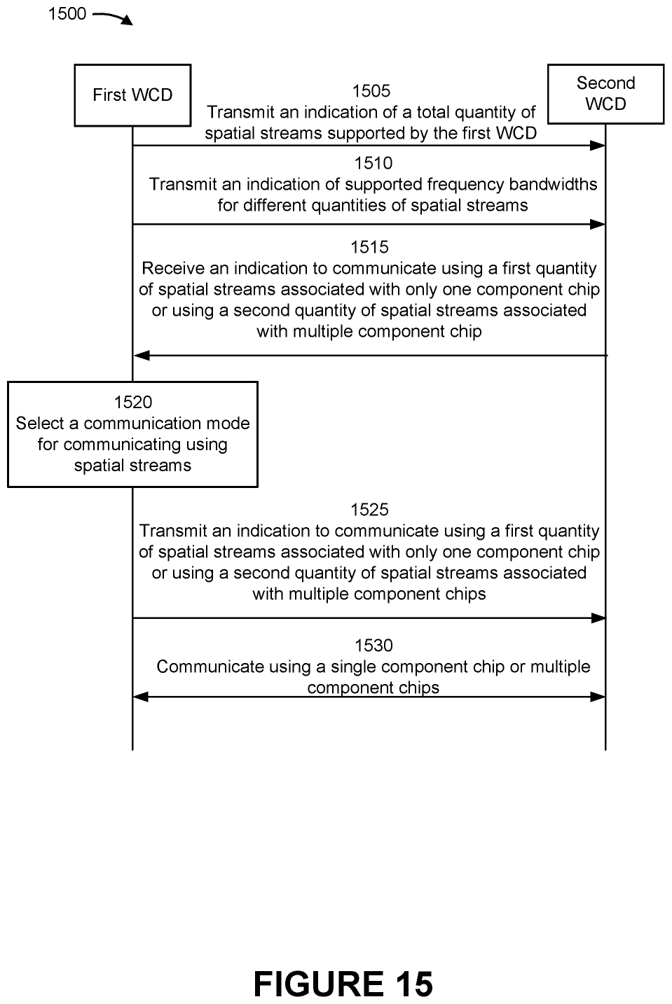

FIG. 15 is a diagram of an example 1500 associated with communicating using multiple component chips as a combined effective chip capable of communicating using a quantity of spatial streams that exceeds a capacity of any one of the multiple component chips when operated independently, in accordance with the present disclosure. As shown in FIG. 15, a first WCD (for example, an AP) may communicate with a second WCD (for example, a second AP or an STA). In some aspects, the first WCD and the second WCD may be part of a wireless network (for example, wireless communication network 100). The first WCD and the second WCD may have established a wireless connection prior to operations shown in FIG. 15.

As shown by reference number 1505, the first WCD may transmit, and the second WCD may receive, an indication of a total quantity of spatial streams supported by the first WCD. In some aspects, the total quantity of spatial streams is a sum of a first quantity of spatial streams supported by a first component chip of the first WCD and a second quantity of spatial streams supported by a second component chip of the first WCD.

As shown by reference number 1510, the first WCD may transmit, and the second WCD may receive, an indication of supported bandwidths for different quantities of spatial streams. For example, the first WCD may transmit an indication of a first supported frequency bandwidth for communication via the first quantity of spatial streams and a second supported frequency bandwidth for communication via the second quantity of spatial streams.

As shown by reference number 1515, the first WCD may receive, and the second WCD may transmit, an indication to communicate using a first quantity of spatial streams associated with only one component chip or using a second quantity of spatial streams associated with multiple component chips. In some aspects, the indication may be based on a quantity of spatial streams supported by the second WCD. In some aspects, the indication may be based on an amount of data buffered for transmission at the second WCD or expected to be communicated between the first WCD and the second WCD.

As shown by reference number 1520, the first WCD may select a communication mode for communicating using spatial streams. In some aspects, the first WCD may select the communication mode based on receiving the indication to communicate using the first quantity of spatial streams or using the second quantity of spatial streams described in connection with reference number 1515. Alternatively, the first WCD may select the communication mode independently from (for example, in absence of) the indication to communicate using the first quantity of spatial streams or using the second quantity of spatial streams described in connection with reference number 1515.

In some aspects, the communication mode may be associated with a quantity of spatial streams for communication, a configuration to communicate via a single frequency channel using the first component chip and the second component chip, or a configuration to communicate via a first frequency band using the first component chip and via a second frequency band using the second component chip. In some aspects, the first WCD may select the quantity of spatial streams based on an amount of data buffered for transmission to the second WCD, a type of communication expected between the first WCD and the second WCD, or a type of device of the second WCD, among other examples.

As shown by reference number 1525, the first WCD may transmit, and the second WCD may receive, an indication to communicate using a first quantity of spatial streams associated with only one component chip or using a second quantity of spatial streams associated with multiple component chips. In some aspects, the first WCD may transmit the indication in a communication that schedules resources for communications between the first WCD and the second WCD. In some aspects, the first WCD may transmit the indication in a communication that requests communication from the second WCD.

As shown by reference number 1530, the first WCD and the second WCD may communicate using a single component chip or multiple component chips. In some aspects, communicating using multiple component chips may include using one or more configurations or arrangements described in connection with FIGS. 3-14.

In some aspects, communicating using the one or more of the first component chip or the second component chip includes providing, to the first component chip and to the second component chip, a set of spatial streams. The WCD may then transmit a first proper subset of the set of spatial streams via the first component chip, and transmit a second proper subset of the set of spatial streams via the second component chip. In some aspects, the WCD may provide the set of spatial streams to the second component chip via the first component chip. For example, the WCD may provide the set of spatial streams to the first component chip, perform MAC layer processing on the set of spatial streams at the first component chip, and provide, after performing the MAC layer processing, the set of spatial streams to the second component chip.

In some aspects, the first component chip may provide synchronization information from the first component chip to the second component chip when using multiple component chips to communicate with the second WCD. For example, the first component chip may provide first synchronization information from a first frequency domain component of the first component chip to a second frequency domain component of the second component chip, or from a first time domain component of the first component chip to a second time domain component of the second component chip. In this way, the first component chip and the second component chip may synchronize in time and frequency to provide a consistent transmission signal to the second WCD or reception signal to the frequency domain components.

To communicate using a single component chip or multiple component chips, the first WCD may include a first component chip having a set of one or more frequency domain components configurable to process a set of spatial streams in a frequency domain and select a first proper subset of spatial streams from the set of spatial streams. The first component chip may also include a frequency-to-time domain mapping component (such as an iDFT or DFT) configured to map the first proper subset of spatial streams from the frequency domain to a time domain. The first component chip may further include a set of one or more time domain components configured to receive, from the frequency-to-time domain mapping component, the first proper subset of spatial streams in the time domain and to transmit the proper subset of spatial streams.

The first component chip may be configured to provide, to one or more additional component chips of the multiple component chips, synchronization information or one or more additional proper subsets of the set of spatial streams not selected for the first proper subset of spatial streams. To communicate the remaining spatial streams not selected for the first proper subset of spatial streams, each of the one or more additional component chips may be configured to transmit a respective subset of spatial streams.

In some aspects, the first component chip includes a set of one or more reception time domain components configured to process a first proper subset of reception spatial streams, the first proper subset of reception spatial streams having a quantity that is equal to a quantity of spatial streams of the proper subset of spatial streams. The first component chip may also include a set of one or more reception frequency domain components configurable to receive a set of reception spatial streams that includes the first proper subset of received spatial streams and a second proper subset of reception spatial streams from a second component chip.

In some aspects, the set of one or more frequency domain components includes a transmission beamformer that is configured to receive the set of spatial streams from a frequency domain component of the set of one or more frequency domain components and to provide the proper subset of spatial streams to the frequency-to-time domain mapping component.

In some aspects, communicating using multiple component chips may include collectively, by the multiple component chips, transmitting or receiving the set of spatial streams using a same frequency channel. In some aspects, communicating using a single component chip may include configuring a set of one or more frequency domain components of the first component chip to process a reduced set of spatial streams, with the reduced set of spatial streams being equal to a number of spatial streams supported by one or more time domain components of the first component chip. In this way, the first component chip may operate independently from the one or more additional component chips.

In some aspects, the first WCD may include a chip-to-chip bus configured to couple the set of one or more frequency domain components of the first component chip to a respective set of one or more frequency domain components of each of one or more additional component chips. When the first WCD is communicating using multiple component chips, the set of one or more frequency domain components of the first component chip may be configured to provide a respective subset of the set of spatial streams via the chip-to-chip bus to each of the one or more additional component chips for transmission.

In some aspects, the chip-to-chip bus may be configured to couple a MAC layer processor of the first component chip with a respective PHY layer processor (for example, an MPI) of each of the one or more additional component chips. In some aspects, the chip-to-chip bus is configured to couple the MAC layer processor of the first component chip with a respective MAC layer processor of each of the one or more additional component chips. In some aspects, the MAC layer processor of the first component chip may be configured to perform a clear channel assessment for the set of spatial streams (for example, for each of the spatial streams that are to be transmitted by the first component chip and the one or more additional component chips to obtain a resource in an associated network), scheduling for the component chip and the one or more additional component chips, or identification of MAC protocol data unit (MPDU) information for the set of spatial streams, among other examples. In this way, MAC processing may be performed only once by the first component chip rather than consuming processing resources of the one or more additional component chips to duplicate the MAC processing.

In some aspects, the first component chip may be configurable for operating with a first frequency bandwidth associated with the set of one or more frequency domain components being configured to process a quantity of spatial streams that is greater than a quantity of spatial streams that can be transmitted or received via the set of one or more time domain components of the first component chip. For example, the first frequency bandwidth may be associated with communicating using multiple component chips. Additionally, or alternatively, the first component chip may be configurable for operating with a second frequency bandwidth associated with the set of one or more frequency domain components being configured to process the set of spatial streams having a quantity that is equal to the quantity of spatial streams that the set of one or more time domain components is configured to receive or transmit.

To receive communications using a single component chip or multiple component chips, the first WCD may have the first component chip configured with a set of one or more time domain components configured to receive a first proper subset of a set of spatial streams in a time domain. The first component chip may also include a time-to-frequency domain mapping component that is configured to receive the first proper subset of the set of spatial streams in the time domain from the set of one or more time domain components and to provide the first proper subset of the set of spatial streams in a frequency domain to a component of a set of one or more frequency domain components. The first component chip may further include the component of the set of one or more frequency domain components that is configured to receive the first proper subset of the set of spatial streams in the frequency domain from the time-to-frequency domain mapping component of the component chip and to receive a second proper subset of the set of spatial streams in the frequency domain from one or more additional component chips.

The first component chip may include a bus configured to couple the set of one or more frequency domain components to the one or more additional component chips. The bus may include a symmetric bus (for example, with support for information transfers to and from the first component chip) or an asymmetric bus (for example, with support for information transfers in only one direction or with an imbalanced throughput in different directions).

In some aspects, the first component chip may include a demodulator that may for example, be configured to receive the first proper subset of the set of spatial streams from the time-to-frequency domain mapping component and to receive the second proper subset of the set of spatial streams from one or more additional component chips.

In some aspects, the first component chip may include a MAC layer processor as a frequency domain component that may for example, be configured to receive a first proper subset of the set of spatial streams from the set of one or more frequency domain components and to receive a second proper subset of the set of spatial streams from the one or more additional component chips via a bus.

In some aspects, the first component chip may be configurable for operating with a first frequency bandwidth associated with processing the set of spatial streams having a first quantity that is greater than a quantity of spatial streams that the set of one or more time domain components is configured to receive. The component chip may be alternatively configurable for operating with a second frequency bandwidth associated with the set of one or more frequency domain components being configured to process the set of spatial streams having a second quantity of spatial streams that is equal to the quantity of spatial streams that the set of one or more time domain components are configured to receive.

Based on the first WCD supporting using a single component chip or multiple component chips (having different antennas) for communicating with the second WCD, with the multiple component chips being configurable to transmit or receive different spatial streams on a single frequency channel, the component chips may have a reduced complexity, reduced manufacturing cost, and may be used in additional implementations when compared to a component chip that supports processing of all spatial streams in the time domain and in the frequency domain. The component chip and the one or more additional component chips may be configured to communicate on a same frequency channel, such that an additional WCD may perceive the WCD as having more antennas than a single component chip has.

As indicated above, FIG. 15 is provided as an example. Other examples may differ from what is described with respect to FIG. 15.

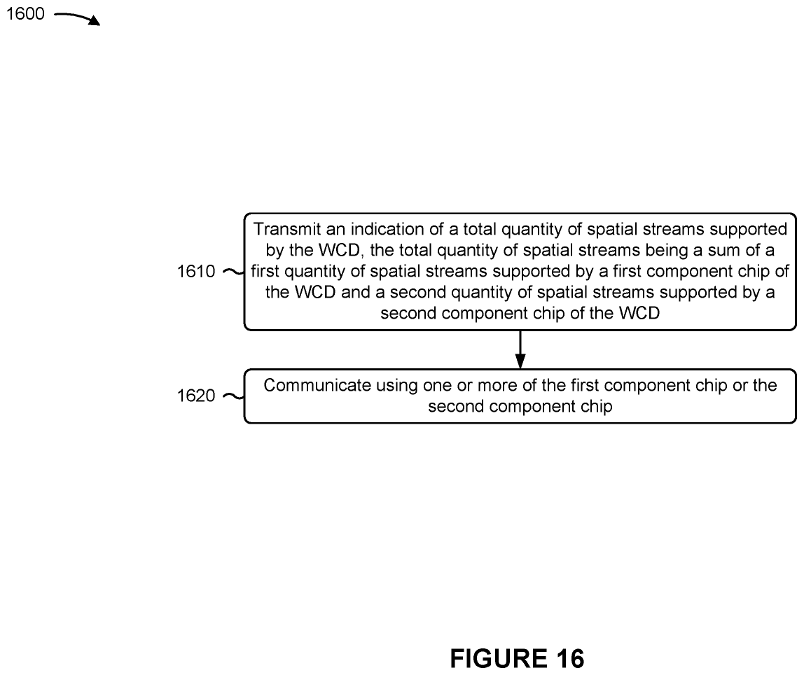

FIG. 16 is a flowchart illustrating an example process 1600 performed, for example, by a WCD that supports communicating using multiple component chips as a combined effective chip capable of communicating using a quantity of spatial streams that exceeds a capacity of any one of the multiple component chips when operated independently, in accordance with the present disclosure. Example process 1600 is an example where the WCD (for example, a WCD implementing component chips shown in one or more of FIGS. 3-14 or the first WCD shown in FIG. 15) performs operations associated with a component chip for wireless communication.

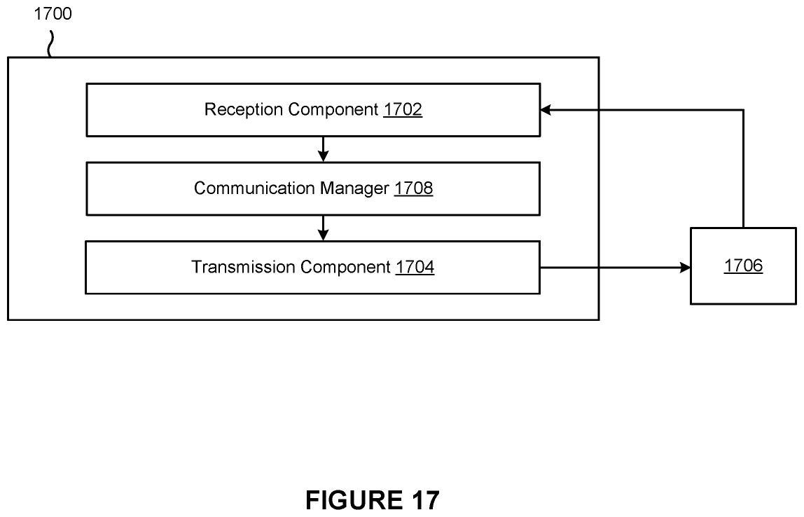

As shown in FIG. 16, in some aspects, process 1600 may include transmitting an indication of a total quantity of spatial streams supported by the WCD, the total quantity of spatial streams being a sum of a first quantity of spatial streams supported by a first component chip of the WCD and a second quantity of spatial streams supported by a second component chip of the WCD (block 1610). For example, the WCD (such as by using communication manager 1708 or transmission component 1704, depicted in FIG. 17) may transmit an indication of a total quantity of spatial streams supported by the WCD, the total quantity of spatial streams being a sum of a first quantity of spatial streams supported by a first component chip of the WCD and a second quantity of spatial streams supported by a second component chip of the WCD, as described above.

As further shown in FIG. 16, in some aspects, process 1600 may include communicating using one or more of the first component chip or the second component chip (block 1620). For example, the WCD (such as by using communication manager 1708, reception component 1702, or transmission component 1704, depicted in FIG. 17) may communicate using one or more of the first component chip or the second component chip, as described above.

Process 1600 may include additional aspects, such as any single aspect or any combination of aspects described below or in connection with one or more other processes described elsewhere herein.

In a first additional aspect, process 1600 includes transmitting an indication of a first supported frequency bandwidth for communication via the first quantity of spatial streams and a second supported frequency bandwidth for communication via the second quantity of spatial streams.

In a second additional aspect, alone or in combination with the first aspect, communicating using the one or more of the first component chip or the second component chip comprises communicating using the first component chip and the second component chip via a same frequency channel.

In a third additional aspect, alone or in combination with one or more of the first and second aspects, communicating using the one or more of the first component chip or the second component chip comprises providing, to the first component chip and to the second component chip, a set of spatial streams, transmitting a first proper subset the set of spatial streams via the first component chip, and transmitting a second proper subset of the set of spatial streams via the second component chip.

In a fourth additional aspect, alone or in combination with one or more of the first through third aspects, providing the set of spatial streams to the second component chip comprises providing the set of spatial streams to the first component chip, performing MAC layer processing on the set of spatial streams, and providing, after performing the MAC layer processing, the set of spatial streams to the second component chip.

In a fifth additional aspect, alone or in combination with one or more of the first through fourth aspects, process 1600 includes providing synchronization information from the first component chip to the second component chip.

In a sixth additional aspect, alone or in combination with one or more of the first through fifth aspects, providing the synchronization information comprises providing one or more of first synchronization information from a first frequency domain component of the first component chip to a second frequency domain component of the second component chip, or second synchronization information from a first time domain component of the first component chip to a second time domain component of the second component chip.

In a seventh additional aspect, alone or in combination with one or more of the first through sixth aspects, process 1600 includes selecting a communication mode for communicating using spatial streams, wherein the communication mode is associated with one or more of a quantity of spatial streams for communication, a configuration to communicate via a single frequency channel using the first component chip and the second component chip, or a configuration to communicate via a first frequency band using the first component chip and via a second frequency band using the second component chip.

In an eighth additional aspect, alone or in combination with one or more of the first through seventh aspects, communicating using the one or more of the first component chip or the second component chip comprises receiving a first proper subset of a set of spatial streams, having the first quantity of spatial streams, via the first component chip, receiving a second proper subset of the set of spatial streams, having the second quantity of spatial streams, via the second component chip, and providing, from the second component chip to the first component chip, the second proper subset of the set of spatial streams.

In a ninth additional aspect, alone or in combination with one or more of the first through eighth aspects, providing the second proper subset of the set of spatial streams to the first component chip comprises one or more of providing the second proper subset of the set of spatial streams after performing discrete Fourier transform (DFT) on the second proper subset of the set of spatial streams, or providing the second proper subset of the set of spatial streams before performing demodulation on the second proper subset of the set of spatial streams.

In a tenth additional aspect, alone or in combination with one or more of the first through ninth aspects, providing the second proper subset of the set of spatial streams to the first component chip comprises one or more of providing the second proper subset of the set of spatial streams after performing decoding on the second proper subset of the set of spatial streams, or providing the second proper subset of the set of spatial streams before performing MAC layer processing on the second proper subset of the set of spatial streams.

In an eleventh additional aspect, alone or in combination with one or more of the first through tenth aspects, process 1600 includes performing demodulation on the first proper subset of the set of spatial streams and the second proper subset of the set of spatial streams.

In a twelfth additional aspect, alone or in combination with one or more of the first through eleventh aspects, process 1600 includes transmitting one or more of an indication to communicate via the first quantity of spatial streams using the first component chip on a first frequency band, or an indication to communicate via the second quantity of spatial streams using the second component chip on a second frequency band that is different from the first frequency band.

In a thirteenth additional aspect, alone or in combination with one or more of the first through twelfth aspects, process 1600 includes receiving one or more of an indication to communicate via the first quantity of spatial streams using the first component chip on a first frequency band, or an indication to communicate via the second quantity of spatial streams using the second component chip on a second frequency band that is different from the first frequency band.

Although FIG. 16 shows example blocks of process 1600, in some aspects, process 1600 may include additional blocks, fewer blocks, different blocks, or differently arranged blocks than those depicted in FIG. 16. Additionally or alternatively, two or more of the blocks of process 1600 may be performed in parallel.

FIG. 17 is a diagram of an example apparatus 1700 for wireless communication that supports communicating using multiple component chips as a combined effective chip capable of communicating using a quantity of spatial streams that exceeds a capacity of any one of the multiple component chips when operated independently, in accordance with the present disclosure. The apparatus 1700 may be a WCD, or a WCD may include the apparatus 1700. In some aspects, the apparatus 1700 includes a reception component 1702, a transmission component 1704, and a communication manager 1708, which may be in communication with one another (for example, via one or more buses). As shown, the apparatus 1700 may communicate with another apparatus 1706 (such as a UE, a network node, or another wireless communication device) using the reception component 1702 and the transmission component 1704.

In some aspects, the apparatus 1700 may be configured to or operable to perform one or more operations described herein in connection with FIGS. 3-15. Additionally or alternatively, the apparatus 1700 may be configured to or operable to perform one or more processes described herein, such as process 1600 of FIG. 16. In some aspects, the apparatus 1700 may include one or more components of the WCD described above in connection with FIGS. 3-14.

The reception component 1702 may receive communications, such as reference signals, control information, or data communications, from the apparatus 1706. The reception component 1702 may provide received communications to one or more other components of the apparatus 1700, such as the communication manager 1708. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1702 may include one or more antennas, a modem, a demodulator, a MIMO detector, a receive processor, a controller/processor, or a memory of the WCD.

The transmission component 1704 may transmit communications, such as reference signals, control information, or data communications, to the apparatus 1706. In some aspects, the communication manager 1708 may generate communications and may transmit the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, or a memory of the WCD. In some aspects, the transmission component 1704 may be co-located with the reception component 1702 in a transceiver.

The communication manager 1708 may transmit or may cause the transmission component 1704 to transmit an indication of a total quantity of spatial streams supported by the WCD, the total quantity of spatial streams being a sum of a first quantity of spatial streams supported by a first component chip of the WCD and a second quantity of spatial streams supported by a second component chip of the WCD. The communication manager 1708 may communicate using one or more of the first component chip or the second component chip. In some aspects, the communication manager 1708 may perform one or more operations described elsewhere herein as being performed by one or more components of the communication manager 1708.

The communication manager 1708 may include a controller/processor, a memory, a scheduler, or a communication unit of the WCD. In some aspects, the communication manager 1708 includes a set of components, such as a processor, a transmission controller, or a reception controller. Alternatively, the set of components may be separate and distinct from the communication manager 1708. In some aspects, one or more components of the set of components may include or may be implemented within a controller/processor, a memory, a scheduler, or a communication unit of the WCD. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1704 may transmit an indication of a total quantity of spatial streams supported by the WCD, the total quantity of spatial streams being a sum of a first quantity of spatial streams supported by a first component chip of the WCD and a second quantity of spatial streams supported by a second component chip of the WCD. The reception component 1702, the transmission component 1704, or the communication manager 1708 may communicate using one or more of the first component chip or the second component chip.

The transmission component 1704 may transmit an indication of a first supported frequency bandwidth for communication via the first quantity of spatial streams and a second supported frequency bandwidth for communication via the second quantity of spatial streams.

The communication manager may cause a first component chip to provide synchronization information from the first component chip to the second component chip.

The communication manager 1708 may select a communication mode for communicating using spatial streams, wherein the communication mode is associated with one or more of: a quantity of spatial streams for communication, a configuration to communicate via a single frequency channel using the first component chip and the second component chip, or a configuration to communicate via a first frequency band using the first component chip and via a second frequency band using the second component chip.

The reception component 1702 (for example, the first component chip) may perform demodulation on the first proper subset of the set of spatial streams and the second proper subset of the set of spatial streams.

The transmission component 1704 may transmit one or more of an indication to communicate via the first quantity of spatial streams using the first component chip on a first frequency band, or an indication to communicate via the second quantity of spatial streams using the second component chip on a second frequency band that is different from the first frequency band.

The reception component 1702 may receive one or more of an indication to communicate via the first quantity of spatial streams using the first component chip on a first frequency band, or an indication to communicate via the second quantity of spatial streams using the second component chip on a second frequency band that is different from the first frequency band.

The number and arrangement of components shown in FIG. 17 are provided as an example. In practice, there may be additional components, fewer components, different components, or differently arranged components than those shown in FIG. 17.

Furthermore, two or more components shown in FIG. 17 may be implemented within a single component, or a single component shown in FIG. 17 may be implemented as multiple, distributed components. Additionally or alternatively, a set of (one or more) components shown in FIG. 17 may perform one or more functions described as being performed by another set of components shown in FIG. 17.

The following provides an overview of some Aspects of the present disclosure:

Aspect 1: A component chip for wireless communication comprising: a set of one or more frequency domain components configurable to process a set of spatial streams in a frequency domain and select a proper subset of spatial streams from the set of spatial streams; a frequency-to-time domain mapping component configured to map the proper subset of spatial streams from the frequency domain to a time domain; and a set of one or more time domain components configured to receive, from the frequency-to-time domain mapping component, the proper subset of spatial streams in the time domain and to transmit the proper subset of spatial streams.

Aspect 2: The component chip of aspect 1, wherein the component chip is configured to provide, to one or more additional component chips, one or more of synchronization information or one or more additional proper subsets of the set of spatial streams not selected for the proper subset of spatial streams, wherein each of the one or more additional component chips is configured to transmit a respective subset of spatial streams.

Aspect 3: The component chip of aspect 2, wherein the component chip and the one or more additional component chips are configured to collectively transmit the set of spatial streams using a same frequency channel.

Aspect 4: The component chip of any of aspects 1-3, wherein the set of one or more frequency domain components comprises a transmission beamformer, and wherein the transmission beamformer is configured to receive the set of spatial streams from a frequency domain component of the set of one or more frequency domain components and to provide the proper subset of spatial streams to the frequency-to-time domain mapping component

Aspect 5: The component chip of any of aspects 1-4, wherein the set of one or more frequency domain components are also configurable to process a reduced set of spatial streams, wherein a quantity of spatial streams of the reduced set of spatial streams is equal to a quantity of spatial streams of the proper subset of spatial streams

Aspect 6: The component chip of any of aspects 1-5, further comprising a chip-to-chip bus configured to couple the set of one or more frequency domain components to a respective set of one or more frequency domain components of each of one or more additional component chips, wherein the set of one or more frequency domain components is configured to provide a respective subset of the set of spatial streams via the chip-to-chip bus to each of the one or more additional component chips.

Aspect 7: The component chip of aspect 6, wherein the chip-to-chip bus is configured to couple a medium access control (MAC) layer processor of the component chip with a respective physical (PHY) layer processor of each of the one or more additional component chips, or wherein the chip-to-chip bus is configured to couple the MAC layer processor of the component chip with a respective MAC layer processor of each of the one or more additional component chips.

Aspect 8: The component chip of any of aspect 7, wherein the component chip is configured to perform one or more of: a clear channel assessment for the set of spatial streams, scheduling for the component chip and the one or more additional component chips, or identification of medium access control (MAC) protocol data unit (MPDU) information for the set of spatial streams.

Aspect 9: The component chip of any of aspects 1-8, further comprising: a set of one or more reception time domain components configured to process a first proper subset of reception spatial streams, the first proper subset of reception spatial streams having a quantity that is equal to a quantity of spatial streams of the proper subset of spatial streams; and a set of one or more reception frequency domain components configurable to receive a set of reception spatial streams that includes the first proper subset of received spatial streams and a second proper subset of reception spatial streams from a second component chip.

Aspect 10: The component chip of any of aspects 1-9, wherein the set of one or more frequency domain components is configurable to process a quantity of spatial streams that is equal to a quantity of spatial streams of the proper subset of spatial streams that the set of one or more time domain components is configured to receive.

Aspect 11: The component chip of any of aspects 1-10, wherein the component chip is configurable for operating with a first frequency bandwidth associated with the set of one or more frequency domain components being configured to process the set of spatial streams having a first quantity that is greater than a quantity of spatial streams of the proper subset of spatial streams that the set of one or more time domain components is configured to receive, wherein, the component chip is configurable for operating with a second frequency bandwidth associated with the set of one or more frequency domain being configured to process the set of spatial streams having a second quantity of spatial streams that is equal to the quantity of spatial streams of the proper subset of spatial streams that the set of one or more time domain components is configured to receive, the second frequency bandwidth being greater than the first frequency bandwidth.

Aspect 12: A system comprising: the component chip of any of aspects 1-11; one or more additional component chips configured to transmit a respective subset of spatial streams; and a chip-to-chip bus configured to couple the set of one or more frequency domain components to an additional set of frequency domain components of the one or more additional component chips.

Aspect 13: A component chip for wireless communication comprising: a set of one or more time domain components configured to receive a first proper subset of a set of spatial streams in a time domain; a time-to-frequency domain mapping component, the time-to-frequency domain mapping component configured to receive the first proper subset of the set of spatial streams in the time domain from the set of one or more time domain components and to provide the first proper subset of the set of spatial streams in a frequency domain to a component of a set of one or more frequency domain components; and the component of the set of one or more frequency domain components that is configured to receive the first proper subset of the set of spatial streams in the frequency domain from the time-to-frequency domain mapping component of the component chip and to receive a second proper subset of the set of spatial streams in the frequency domain from one or more additional component chips.

Aspect 14: The component chip of aspects 13, further comprising a bus configured to couple the set of one or more frequency domain components to the one or more additional component chips.

Aspect 15: The component chip of aspect 14, wherein the bus comprises: a symmetric bus, or an asymmetric bus.

Aspect 16: The component chip of any of aspects 13-15, wherein the component of the set of one or more frequency domain components comprises a demodulator.

Aspect 17: The component chip of any of aspect 16, wherein the demodulator is configured to receive the first proper subset of the set of spatial streams from the time-to-frequency domain mapping component and to receive the second proper subset of the set of spatial streams from one or more additional component chips.

Aspect 18: The component chip of any of aspects 13-17, wherein the set of one or more frequency domain components comprises a medium access control (MAC) layer processor, wherein the MAC layer processor is configured to receive the first proper subset of the set of spatial streams from the set of one or more frequency domain components and to receive the second proper subset of the set of spatial streams from the one or more additional component chips via a bus.

Aspect 19: The component chip of any of aspects 13-18, wherein the set of one or more frequency domain components is configurable to process the first proper subset of the set of spatial streams and not the second proper subset of the set of spatial streams.

Aspect 20: The component chip of aspect 19, wherein the component chip is configurable for operating with a first frequency bandwidth associated with the set of one or more frequency domain components being configured to process the set of spatial streams having a first quantity that is greater than a quantity of spatial streams of the first proper subset of the set of spatial streams that the set of one or more time domain components is configured to receive, wherein, the component chip is configurable for operating with a second frequency bandwidth associated with the set of one or more frequency domain components being configured to process the set of spatial streams having a second quantity of spatial streams that is equal to the quantity of spatial streams of the first proper subset of spatial streams that the set of one or more time domain components are configured to receive, the second frequency bandwidth being greater than the first frequency bandwidth.

Aspect 21: A system comprising: the component chip of claim 13; the one or more additional component chips; and a chip-to-chip bus configured to couple the set of one or more frequency domain components to an additional set of frequency domain components of the one or more additional component chips.

Aspect 22: A method for wireless communication performable at a wireless communication device (WCD), comprising: transmitting an indication of a total quantity of spatial streams supported by the WCD, the total quantity of spatial streams being a sum of a first quantity of spatial streams supported by a first component chip of the WCD and a second quantity of spatial streams supported by a second component chip of the WCD; and communicating using one or more of the first component chip or the second component chip.

Aspect 23: The method of Aspect 22, further comprising: transmitting an indication of a first supported frequency bandwidth for communication via the first quantity of spatial streams and a second supported frequency bandwidth for communication via the second quantity of spatial streams.

Aspect 24: The method of any of Aspects 22-23, wherein communicating using the one or more of the first component chip or the second component chip comprises: communicating using the first component chip and the second component chip via a same frequency channel.

Aspect 25: The method of any of Aspects 22-24, wherein communicating using the one or more of the first component chip or the second component chip comprises: providing, to the first component chip and to the second component chip, a set of spatial streams; transmitting a first proper subset the set of spatial streams via the first component chip; and transmitting a second proper subset of the set of spatial streams via the second component chip.

Aspect 26: The method of Aspect 25, wherein providing the set of spatial streams to the second component chip comprises: providing the set of spatial streams to the first component chip; performing medium access control (MAC) layer processing on the set of spatial streams; and providing, after performing the MAC layer processing, the set of spatial streams to the second component chip.

Aspect 27: The method of any of Aspects 22-26, further comprising: providing synchronization information from the first component chip to the second component chip.

Aspect 28: The method of Aspect 27, wherein providing the synchronization information comprises providing one or more of: first synchronization information from a first frequency domain component of the first component chip to a second frequency domain component of the second component chip, or second synchronization information from a first time domain component of the first component chip to a second time domain component of the second component chip.

Aspect 29: The method of any of Aspects 22-28, further comprising selecting a communication mode for communicating using spatial streams, wherein the communication mode is associated with one or more of: a quantity of spatial streams for communication, a configuration to communicate via a single frequency channel using the first component chip and the second component chip, or a configuration to communicate via a first frequency band using the first component chip and via a second frequency band using the second component chip.

Aspect 30: The method of any of Aspects 22-29, wherein communicating using the one or more of the first component chip or the second component chip comprises: receiving a first proper subset of a set of spatial streams, having the first quantity of spatial streams, via the first component chip; receiving a second proper subset of the set of spatial streams, having the second quantity of spatial streams, via the second component chip; and providing, from the second component chip to the first component chip, the second proper subset of the set of spatial streams.

Aspect 31: The method of Aspect 30, wherein providing the second proper subset of the set of spatial streams to the first component chip comprises one or more of: providing the second proper subset of the set of spatial streams after performing discrete Fourier transform (DFT) on the second proper subset of the set of spatial streams, or providing the second proper subset of the set of spatial streams before performing demodulation on the second proper subset of the set of spatial streams.

Aspect 32: The method of Aspect 31, wherein providing the second proper subset of the set of spatial streams to the first component chip comprises one or more of: providing the second proper subset of the set of spatial streams after performing decoding on the second proper subset of the set of spatial streams, or providing the second proper subset of the set of spatial streams before performing medium access control (MAC) layer processing on the second proper subset of the set of spatial streams.

Aspect 33: The method of Aspect 31, further comprising: performing demodulation on the first proper subset of the set of spatial streams and the second proper subset of the set of spatial streams.

Aspect 34: The method of any of Aspects 22-33, further comprising transmitting one or more of: an indication to communicate via the first quantity of spatial streams using the first component chip on a first frequency band, or an indication to communicate via the second quantity of spatial streams using the second component chip on a second frequency band that is different from the first frequency band.

Aspect 35: The method of any of Aspects 22-34, further comprising receiving one or more of: an indication to communicate via the first quantity of spatial streams using the first component chip on a first frequency band, or an indication to communicate via the second quantity of spatial streams using the second component chip on a second frequency band that is different from the first frequency band.

Aspect 36: An apparatus for wireless communication at a device, comprising a processor; memory coupled with the processor; and instructions stored in the memory and executable by the processor to cause the apparatus to perform the method of one or more of Aspects 1-35.

Aspect 37: A device for wireless communication, comprising a memory and one or more processors coupled to the memory, the one or more processors configured to perform the method of one or more of Aspects 1-35.

Aspect 38: An apparatus for wireless communication, comprising at least one means for performing the method of one or more of Aspects 1-35.

Aspect 39: A non-transitory computer-readable medium storing code for wireless communication, the code comprising instructions executable by a processor to perform the method of one or more of Aspects 1-35.

Aspect 40: A non-transitory computer-readable medium storing a set of instructions for wireless communication, the set of instructions comprising one or more instructions that, when executed by one or more processors of a device, cause the device to perform the method of one or more of Aspects 1-35.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A component chip for wireless communication comprising:
a set of one or more frequency domain components configurable to process a set of spatial streams in a frequency domain and select a proper subset of spatial streams from the set of spatial streams;
a frequency-to-time domain mapping component configured to map the proper subset of spatial streams from the frequency domain to a time domain; and
a set of one or more time domain components configured to receive, from the frequency-to-time domain mapping component, the proper subset of spatial streams in the time domain and to transmit the proper subset of spatial streams.

2. The component chip of claim 1, wherein the component chip is configured to provide, to one or more additional component chips, one or more of synchronization information or one or more additional proper subsets of the set of spatial streams not selected for the proper subset of spatial streams,
wherein each of the one or more additional component chips is configured to transmit a respective subset of spatial streams.

3. The component chip of claim 2, wherein the component chip and the one or more additional component chips are configured to collectively transmit the set of spatial streams using a same frequency channel.

4. The component chip of claim 1, wherein the set of one or more frequency domain components comprises a transmission beamformer, and
wherein the transmission beamformer is configured to receive the set of spatial streams from a frequency domain component of the set of one or more frequency domain components and to provide the proper subset of spatial streams to the frequency-to-time domain mapping component.

5. The component chip of claim 1, wherein the set of one or more frequency domain components are also configurable to process a reduced set of spatial streams,
wherein a quantity of spatial streams of the reduced set of spatial streams is equal to a quantity of spatial streams of the proper subset of spatial streams.

6. The component chip of claim 1, further comprising a chip-to-chip bus configured to couple the set of one or more frequency domain components to a respective set of one or more frequency domain components of each of one or more additional component chips,
wherein the set of one or more frequency domain components is configured to provide a respective subset of the set of spatial streams via the chip-to-chip bus to each of the one or more additional component chips.

7. The component chip of claim 6, wherein the chip-to-chip bus is configured to couple a medium access control (MAC) layer processor of the component chip with a respective physical (PHY) layer processor of each of the one or more additional component chips, or
wherein the chip-to-chip bus is configured to couple the MAC layer processor of the component chip with a respective MAC layer processor of each of the one or more additional component chips.

8. The component chip of claim 7, wherein the component chip is configured to perform one or more of:
a clear channel assessment for the set of spatial streams,
scheduling for the component chip and the one or more additional component chips, or
identification of medium access control (MAC) protocol data unit (MPDU) information for the set of spatial streams.

9. The component chip of claim 1, further comprising:
a set of one or more reception time domain components configured to process a first proper subset of reception spatial streams, the first proper subset of reception spatial streams having a quantity that is equal to a quantity of spatial streams of the proper subset of spatial streams; and
a set of one or more reception frequency domain components configurable to receive a set of reception spatial streams that includes the first proper subset of received spatial streams and a second proper subset of reception spatial streams from a second component chip.

10. The component chip of claim 1, wherein the set of one or more frequency domain components is configurable to process a quantity of spatial streams that is equal to a quantity of spatial streams of the proper subset of spatial streams that the set of one or more time domain components is configured to receive.

11. The component chip of claim 1, wherein the component chip is configurable for operating with a first frequency bandwidth associated with the set of one or more frequency domain components being configured to process the set of spatial streams having a first quantity that is greater than a quantity of spatial streams of the proper subset of spatial streams that the set of one or more time domain components is configured to receive,
wherein, the component chip is configurable for operating with a second frequency bandwidth associated with the set of one or more frequency domain being configured to process the set of spatial streams having a second quantity of spatial streams that is equal to the quantity of spatial streams of the proper subset of spatial streams that the set of one or more time domain components is configured to receive, the second frequency bandwidth being greater than the first frequency bandwidth.

12. A system comprising:
the component chip of claim 1;
one or more additional component chips configured to transmit a respective subset of spatial streams; and
a chip-to-chip bus configured to couple the set of one or more frequency domain components to an additional set of frequency domain components of the one or more additional component chips.

13. A component chip for wireless communication comprising:
a set of one or more time domain components configured to receive a first proper subset of a set of spatial streams in a time domain;
a time-to-frequency domain mapping component, the time-to-frequency domain mapping component configured to receive the first proper subset of the set of spatial streams in the time domain from the set of one or more time domain components and to provide the first proper subset of the set of spatial streams in a frequency domain to a component of a set of one or more frequency domain components; and
the component of the set of one or more frequency domain components that is configured to receive the first proper subset of the set of spatial streams in the frequency domain from the time-to-frequency domain mapping component of the component chip and to receive a second proper subset of the set of spatial streams in the frequency domain from one or more additional component chips.

14. The component chip of claim 13, further comprising a bus configured to couple the set of one or more frequency domain components to the one or more additional component chips.

15. The component chip of claim 14, wherein the bus comprises:
a symmetric bus, or
an asymmetric bus.

16. The component chip of claim 13, wherein the component of the set of one or more frequency domain components comprises a demodulator.

17. The component chip of claim 16, wherein the demodulator is configured to receive the first proper subset of the set of spatial streams from the time-to-frequency domain mapping component and to receive the second proper subset of the set of spatial streams from one or more additional component chips.

18. The component chip of claim 13, wherein the set of one or more frequency domain components comprises a medium access control (MAC) layer processor,
wherein the MAC layer processor is configured to receive the first proper subset of the set of spatial streams from the set of one or more frequency domain components and to receive the second proper subset of the set of spatial streams from the one or more additional component chips via a bus.

19. The component chip of claim 13, wherein the set of one or more frequency domain components is configurable to process the first proper subset of the set of spatial streams and not the second proper subset of the set of spatial streams.

20. The component chip of claim 19, wherein the component chip is configurable for operating with a first frequency bandwidth associated with the set of one or more frequency domain components being configured to process the set of spatial streams having a first quantity that is greater than a quantity of spatial streams of the first proper subset of the set of spatial streams that the set of one or more time domain components is configured to receive, and
wherein the component chip is configurable for operating with a second frequency bandwidth associated with the set of one or more frequency domain components being configured to process the set of spatial streams having a second quantity of spatial streams that is equal to the quantity of spatial streams of the first proper subset of spatial streams that the set of one or more time domain components are configured to receive, the second frequency bandwidth being greater than the first frequency bandwidth.

21. A system comprising:
the component chip of claim 13;
the one or more additional component chips; and
a chip-to-chip bus configured to couple the set of one or more frequency domain components to an additional set of frequency domain components of the one or more additional component chips.

22. A method for wireless communication performable at a wireless communication device (WCD), comprising:
transmitting an indication of a total quantity of spatial streams supported by the WCD, the total quantity of spatial streams being a sum of a first quantity of spatial streams supported by a first component chip of the WCD and a second quantity of spatial streams supported by a second component chip of the WCD; and
communicating using one or more of the first component chip or the second component chip.

23. The method of claim 22, further comprising:
transmitting an indication of a first supported frequency bandwidth for communication via the first quantity of spatial streams and a second supported frequency bandwidth for communication via the second quantity of spatial streams.

24. The method of claim 22, wherein communicating using the one or more of the first component chip or the second component chip comprises:
communicating using the first component chip and the second component chip via a same frequency channel.

25. The method of claim 22, wherein communicating using the one or more of the first component chip or the second component chip comprises:
providing, to the first component chip and to the second component chip, a set of spatial streams;
transmitting a first proper subset the set of spatial streams via the first component chip; and
transmitting a second proper subset of the set of spatial streams via the second component chip.

26. The method of claim 25, wherein providing the set of spatial streams to the second component chip comprises:
providing the set of spatial streams to the first component chip;
performing medium access control (MAC) layer processing on the set of spatial streams; and
providing, after performing the MAC layer processing, the set of spatial streams to the second component chip.

27. The method of claim 22, further comprising:
providing synchronization information from the first component chip to the second component chip.

28. The method of claim 27, wherein providing the synchronization information comprises providing one or more of:
first synchronization information from a first frequency domain component of the first component chip to a second frequency domain component of the second component chip, or
second synchronization information from a first time domain component of the first component chip to a second time domain component of the second component chip.

29. The method of claim 22, further comprising selecting a communication mode for communicating using spatial streams,
wherein the communication mode is associated with one or more of:
a quantity of spatial streams for communication,
a configuration to communicate via a single frequency channel using the first component chip and the second component chip, or
a configuration to communicate via a first frequency band using the first component chip and via a second frequency band using the second component chip.

30. The method of claim 22, wherein communicating using the one or more of the first component chip or the second component chip comprises:
receiving a first proper subset of a set of spatial streams, having the first quantity of spatial streams, via the first component chip;
receiving a second proper subset of the set of spatial streams, having the second quantity of spatial streams, via the second component chip; and
providing, from the second component chip to the first component chip, the second proper subset of the set of spatial streams.

31. The method of claim 30, wherein providing the second proper subset of the set of spatial streams to the first component chip comprises one or more of:
providing the second proper subset of the set of spatial streams after performing discrete Fourier transform (DFT) on the second proper subset of the set of spatial streams, or
providing the second proper subset of the set of spatial streams before performing demodulation on the second proper subset of the set of spatial streams.

32. The method of claim 31, wherein providing the second proper subset of the set of spatial streams to the first component chip comprises one or more of:
providing the second proper subset of the set of spatial streams after performing decoding on the second proper subset of the set of spatial streams, or
providing the second proper subset of the set of spatial streams before performing medium access control (MAC) layer processing on the second proper subset of the set of spatial streams.

33. The method of claim 31, further comprising:
performing demodulation on the first proper subset of the set of spatial streams and the second proper subset of the set of spatial streams.

34. The method of claim 22, further comprising transmitting one or more of:
an indication to communicate via the first quantity of spatial streams using the first component chip on a first frequency band, or
an indication to communicate via the second quantity of spatial streams using the second component chip on a second frequency band that is different from the first frequency band.

35. The method of claim 22, further comprising receiving one or more of:
an indication to communicate via the first quantity of spatial streams using the first component chip on a first frequency band, or
an indication to communicate via the second quantity of spatial streams using the second component chip on a second frequency band that is different from the first frequency band.
